(19) United States
(12) Patent Application Publication
(10) Pub. No.: US 2025/0220474 A1
(43) Pub. Date: Jul. 3, 2025

(54) MODEL MONITORING METHOD, TERMINAL DEVICE AND NETWORK DEVICE

(71) Applicant: GUANGDONG OPPO MOBILE TELECOMMUNICATIONS CORP., LTD., Dongguan (CN)

(72) Inventors: Zhe LIU, Dongguan (CN); Zhihua SHI, Dongguan (CN); Yingpei HUANG, Dongguan (CN)

(21) Appl. No.: 19/088,380

(22) Filed: Mar. 24, 2025

Related U.S. Application Data
(63) Continuation of application No. PCT/CN2022/123329, filed on Sep. 30, 2022.

(51) Int. Cl. H04W 24/08; H04L 5/00; H04W 64/00

(52) U.S. Cl. CPC H04W 24/08; H04L 5/0048; H04W 64/003

(57) ABSTRACT

A model monitoring method includes: receiving, by a terminal device, first information, where the first information includes at least configuration information used for monitoring a first neural network model, and the first neural network model is used for performing terminal positioning; and monitoring, by the terminal device, the first neural network model according to the first information.

### CROSS-REFERENCE TO RELATED APPLICATION

This application is a Continuation Application of International Application No. PCT/CN2022/123329 filed on Sep. 30, 2022, which is incorporated herein by reference in its entirety.

### TECHNICAL FIELD

Embodiments of the present application relate to the field of communications, and in particular, to a model monitoring method, a terminal device, and a network device.

### BACKGROUND

In a new radio (NR) system, artificial intelligence (AI)/machine learning (ML) may be introduced to enhance system performance. For example, the AI/ML is introduced for terminal positioning, that is, the accuracy of terminal positioning is improved by predicting terminal location information with a trained AI/ML model. However, if a wireless propagation environment changes, the effectiveness of the AI/ML model will be restricted. How to monitor the effectiveness of the AI/ML model is a problem that needs to be solved.

### SUMMARY

In a first aspect, a model monitoring method is provided, and the method includes:
receiving, by a terminal device, first information, where the first information includes at least configuration information used for monitoring a first neural network model, and the first neural network model is used for performing terminal positioning; and
monitoring, by the terminal device, the first neural network model according to the first information.

In a second aspect, a model monitoring method is provided, and the method includes:
transmitting, by a network device, first information, where the first information includes at least configuration information used for monitoring a first neural network model, and the first neural network model is used for performing terminal positioning; and the first information is used for a terminal device to monitor the first neural network model.

In a third aspect, a terminal device is provided, which is configured to perform the method in the above first aspect.

In some embodiments, the terminal device includes functional modules configured to perform the method in the above first aspect.

In a fourth aspect, a network device is provided, which is configured to perform the method in the above second aspect.

In some embodiments, the network device includes a functional module configured to perform the method in the above second aspect.

In a fifth aspect, a terminal device is provided, and the terminal device includes: a processor and a memory. The memory is configured to store a computer program, and the processor is configured to call the computer program stored in the memory and run the computer program to enable the terminal device to perform the method in the above first aspect.

In a sixth aspect, a network device is provided, and the network device includes: a processor and a memory. The memory is configured to store a computer program, and the processor is configured to call the computer program stored in the memory and run the computer program to enable the network device to perform the method in the above second aspect.

In a seventh aspect, an apparatus is provided, which is configured to implement the method in any one of the above first to second aspects.

In some embodiments, the apparatus includes a processor, and the processor is configured to call a computer program from a memory and run the computer program to enable a device equipped with the apparatus to perform the method in any one of the above first to second aspects.

In an eighth aspect, a non-transitory computer-readable storage medium is provided, which is configured to store a computer program. The computer program enables a computer to perform the method in any one of the above first to second aspects.

In a ninth aspect, a computer program product is provided, which includes computer program instructions. The computer program instructions enable a computer to perform the method in any one of the above first to second aspects.

In a tenth aspect, a computer program is provided, and the computer program, when executed on a computer, enables the computer to perform the method in any one of the above first to second aspects.

### BRIEF DESCRIPTION OF THE DRAWINGS

FIG. 1 is a schematic diagram of an architecture of a communication system to which the embodiments of the present application are applied.

FIG. 2 is a schematic diagram of a neuron provided in the present application.

FIG. 3 is a schematic diagram of a neural network provided in the present application.

FIG. 4 is a schematic diagram of a convolutional neural network provided in the present application.

FIG. 5 is a schematic diagram of an LSTM unit provided in the present application.

FIG. 6 is a schematic diagram of a combination of an AI/ML model and a positioning method provided in the present application.

FIG. 7 is a schematic flowchart of a model monitoring method provided in accordance with the embodiments of the present application.

FIG. 8 is a schematic diagram of a first time window provided in accordance with the embodiments of the present application.

FIG. 9 is a schematic flowchart of a model monitoring provided in accordance with the embodiments of the present application.

FIG. 10 is a schematic flowchart of another model monitoring provided in accordance with the embodiments of the present application.

FIG. 11 is a schematic block diagram of a terminal device provided in accordance with the embodiments of the present application.

FIG. 12 is a schematic block diagram of a network device provided in accordance with the embodiments of the present application.

FIG. 13 is a schematic block diagram of a communication device provided in accordance with the embodiments of the present application.

FIG. 14 is a schematic block diagram of an apparatus provided in accordance with the embodiments of the present application.

FIG. 15 is a schematic block diagram of a communication system provided in accordance with the embodiments of the present application.

### DETAILED DESCRIPTION

Technical solutions in the embodiments of the present application will be described below with reference to the accompanying drawings of the embodiments of the present application. Obviously, the described embodiments are merely some but not all of the embodiments of the present application. All other embodiments obtained based on the embodiments of the present application by those ordinary skilled in the art shall be included in the protection scope of the present application.

The technical solutions of the embodiments of the present application may be applied to various communication systems, such as a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial communication network (NTN) system, a universal mobile telecommunication system (UMTS), a wireless local area network (WLAN), an internet of things (IoT), a wireless fidelity (WiFi), a 5th-generation (5G) communication system, a 6th-generation (6G) communication system, or other communication systems.

Generally speaking, connections supported by a traditional communication system have a limited number and are easy to be implemented. However, with the development of the communication technology, mobile communication systems will not only support the traditional communication, but will further support, for example, device to device (D2D) communication, machine to machine (M2M) communication, machine type communication (MTC), vehicle to vehicle (V2V) communication, sidelink (SL) communication, vehicle to everything (V2X) communication, and the embodiments of the present application may also be applied to these communication systems.

In some embodiments, the communication system in the embodiments of the present application may be applied to a carrier aggregation (CA) scenario, may also be applied to a dual connectivity (DC) scenario, and may also be applied to a standalone (SA) network deployment scenario, or be applied to a non-standalone (NSA) network deployment scenario.

In some embodiments, the communication system in the embodiments of the present application may be applied to an unlicensed spectrum, where the unlicensed spectrum may also be considered as a shared spectrum; or the communication system in the embodiments of the present application may be applied to a licensed spectrum, where the licensed spectrum may also be considered as an unshared spectrum.

In some embodiments, the communication system in the embodiments of the present application may be applied to an FR1 frequency band (corresponding to a frequency range of 410 MHz to 7.125 GHz), an FR2 frequency band (corresponding to a frequency range of 24.25 GHz to 52.6 GHz), and may also be applied to new frequency bands such as a high-frequency frequency band corresponding to a frequency range of 52.6 GHz to 71 GHz or a frequency range of 71 GHz to 114.25 GHz.

The embodiments of the present application describe various embodiments in conjunction with a network device and a terminal device, where the terminal device may also be referred to as a user equipment (UE), an access terminal, a user unit, a user station, a mobile station, a mobile console, a remote station, a remote terminal, a mobile device, a user terminal, a terminal, a wireless communication device, a user agent or user apparatus, or the like.

The terminal device may be a station (STATION, STA) in the WLAN, which may be a cellular phone, a cordless phone, a session initiation protocol (SIP) phone, a wireless local loop (WLL) station, a personal digital assistant (PDA) device, a handheld device with a wireless communication function, a computing device or other processing devices connected to a wireless modem, a vehicle-mounted device, a wearable device, a terminal device in a next-generation communication system (such as in an NR network), a terminal device in a public land mobile network (PLMN) evolved in the future, or the like.

In the embodiments of the present application, the terminal device may be deployed on land, which includes being deployed indoor or outdoor, in handheld, worn or vehicle-mounted; the terminal device may also be deployed on water (e.g., on a ship); and the terminal device may also be deployed in the air (e.g., on an airplane, a balloon, and a satellite).

In the embodiments of the present application, the terminal device may be a mobile phone, a pad, a computer with a wireless transceiving function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, a vehicle-mounted communication device, a wireless communication chip/application specific integrated circuit (ASIC)/system on chip (SoC), or the like.

As an example but not a limitation, in the embodiments of the present application, the terminal device may also be a wearable device. The wearable device, which is also referred to as a wearable smart device, is a generic term for a device capable of being worn, into which the daily wear is intelligently designed and developed by applying wearable technologies, such as glasses, gloves, watches, clothing, and shoes. The wearable device is a portable device that is worn directly on the body, or integrated into the user's clothing or accessories. The wearable device is not only a hardware device, but also achieves powerful functions through software support, data interaction, and cloud interaction. A generalized wearable smart device includes, for example, a smartwatch or smart glasses, with full functions, large size, and entire or partial functions without relying on a smartphone, as well as, for example, a smart bracelet or smart jewelry for physical sign monitoring, which only focuses on a certain type of application function and needs to be used in conjunction with other devices such as a smartphone.

In the embodiments of the present application, the network device may be a device used for communicating with a mobile device. The network device may be an access point (AP) in the WLAN, a base station (Base Transceiver Station, BTS) in the GSM or CDMA, a base station (NodeB, NB) in the WCDMA, an evolutional base station (Evolutional Node B, eNB or eNodeB) in the LTE, a relay station or access point, a vehicle-mounted device, a wearable device, a network device or a base station (gNB) or a transmission reception point (TRP) in an NR network, a network device in the PLMN evolved in the future, a network device in the NTN, or the like.

As an example but not a limitation, in the embodiments of the present application, the network device may have a mobile characteristic, for example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments, the network device may be a base station provided on land, water, or other places.

In the embodiments of the present application, the network device may provide a service for a cell, and the terminal device communicates with the network device through a transmission resource (e.g., a frequency domain resource, or a frequency spectrum resource) used by the cell. The cell may be a cell corresponding to the network device (e.g., a base station), the cell may belong to a macro base station or may belong to a base station corresponding to a small cell, and small cells here may include: a metro cell, a micro cell, a pico cell, a femto cell, etc. These small cells have features of a small coverage range and a low transmit power, which are applicable for providing a data transmission service with high speed.

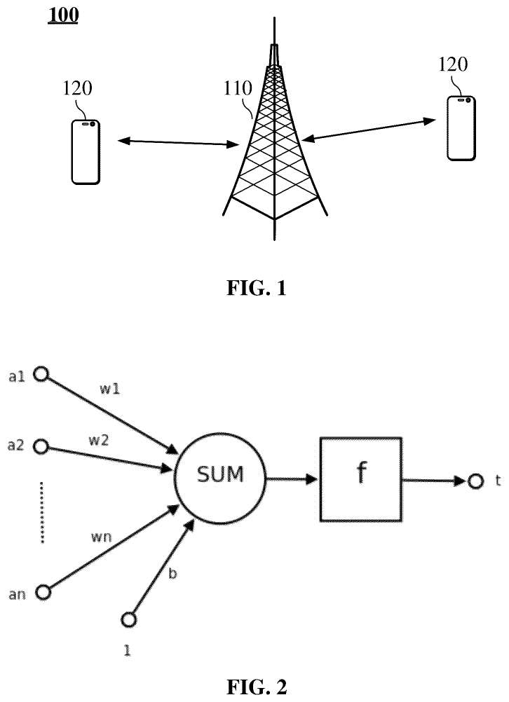

Exemplarily, a communication system 100 to which the embodiments of the present application are applied is shown in FIG. 1. The communication system 100 may include a network device 110, and the network device 110 may be a device that communicates with a terminal device 120 (also referred to as a communication terminal or a terminal). The network device 110 may provide communication coverage for a specific geographical area and may communicate with a terminal device located within the coverage area.

FIG. 1 exemplarily illustrates one network device and two terminal devices. In some embodiments, the communication system 100 may include multiple network devices and may include another number of terminal devices within a coverage range of each network device, the embodiments of the present application are not limited thereto.

In some embodiments, the communication system 100 may further include other network entities such as a network controller and a mobility management entity, which are not limited to the embodiments of the present application.

It should be understood that in the embodiments of the present application, a device with a communication function in the network/system may be referred to as a communication device. Taking the communication system 100 shown in FIG. 1 as an example, communication devices may include the network device 110 and the terminal device 120 that have the communication function, and the network device 110 and the terminal device 120 may be the devices described above, which will not be repeated herein; and the communication devices may further include other devices in the communication system 100, such as a network controller, a mobility management entity, and other network entities, which are not limited in the embodiments of the present application.

It should be understood that the terms “system” and “network” are often used interchangeably herein. The term “and/or” herein is only an association relationship to describe associated objects, which means that there may be three kinds of relationships. For example, A and/or B may represent three cases that: A exists alone, both A and B exist, and B exists alone. In addition, the character “/” herein generally means that related objects before and after “/” are in an “or” relationship.

It should be understood that for the terminal device and network device involved herein, the terminal device may be, for example, a mobile phone, a machine facility, a customer premise equipment (CPE), an industrial device, a vehicle, or the like, and the network device may be an opposite communication device of the terminal device, such as a base station (gNB), an AMF entity, an LMF entity, or the like.

The terms used in the detailed description of the present application are only used to explain the embodiments of the present application and are not intended to limit the present application. The terms “first”, “second”, “third”, “fourth” etc., in the specification, claims and drawings of the present application are used to distinguish different objects rather than to describe an order. In addition, the terms “include” and “have” and any variations thereof, are intended to cover a non-exclusive inclusion.

It should be understood that “indicate” mentioned in the embodiments of the present application may mean a direct indication, may mean an indirect indication, or may represent that there is an association relationship. By way of example, A indicates B, which may mean that A directly indicates B (for example, B may be obtained by A) or may mean that A indirectly indicates B (for example, A indicates C, and B may be obtained by C), or may mean that there is an association relationship between A and B.

In the description of the embodiments of the present application, the term “correspond” may mean that there is a direct correspondence or indirect correspondence between two, or it may mean that there is an associated relationship between the two, or it may mean a relationship of indicating and being indicated, a relationship of configuring and being configured, or the like.

In the embodiments of the present application, “predefined” or “preconfigured” may be implemented by pre-saving corresponding codes, tables or other manners usable for indicating related information, in the devices (for example, including the terminal device and the network device), and the present application does not limit its implementation. For example, the predefined may refer to being defined in a protocol.

In the embodiments of the present application, the “protocol” may refer to a standard protocol in the field of communication, for example, it may be an evolution of an existing LTE protocol, an NR protocol, a Wi-Fi protocol, or a protocol related to other communication systems related to the foregoing. The present application does not limit the protocol type.

To facilitate the understanding of the technical solutions in the embodiments of the present application, the technical solutions of the present application will be described in detail below through some embodiments. The above related technologies, as optional solutions, may be arbitrarily combined with the technical solutions of the embodiments of the present application, and those combined solutions all fall within the protection scope of the embodiments of the present application. The embodiments of the present application include at least a part of the following contents.

To facilitate a proper understanding of the embodiments of the present application, neural networks and machine learning (ML) related to the present application are described.

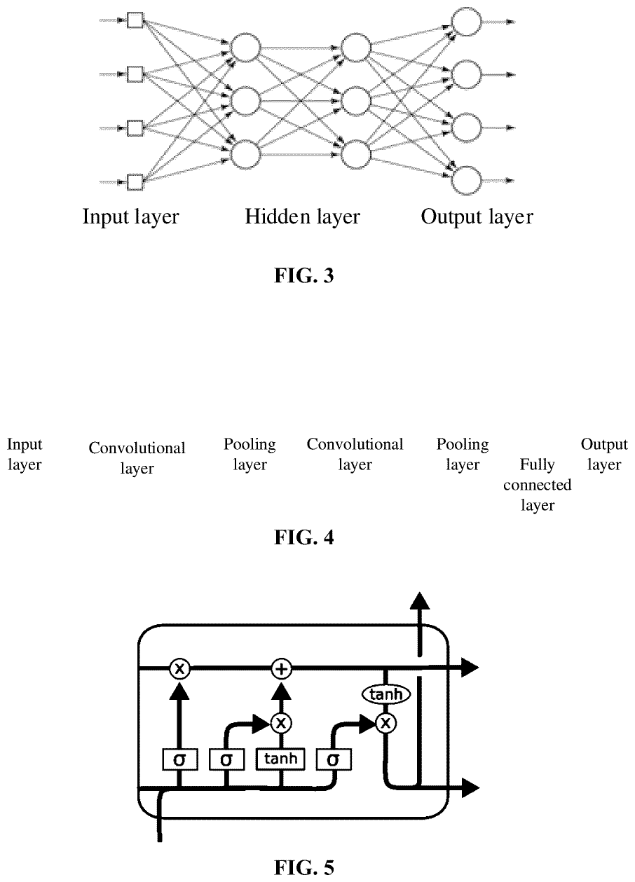

A neural network is a computing model consisting of multiple neuron nodes interconnected, where a connection between nodes indicates a weighted value from an input signal to an output signal, called a weight; and each node performs a weighted summation (SUM) on different input signals, and outputs them through a specific activation function (f). An example of a neuron structure is shown in FIG. 2. A simple neural network is shown in FIG. 3, which includes an input layer, a hidden layer, and an output layer. Different outputs may be generated through different connection methods, weights, and activation functions of multiple neurons, thereby fitting a mapping relationship from input to output.

Deep learning uses deep neural networks with multiple hidden layers, which greatly improves the ability of the network to learn features and may fit complex non-linear mappings from input to output, and is thus widely used in speech and image processing fields. In addition to deep neural networks, facing different tasks, deep learning further includes a convolutional neural network (CNN), a recurrent neural network (RNN) and other common basic structures.

The basic structure of a convolutional neural network includes: an input layer, multiple convolutional layers, multiple pooling layers, a fully connected layer, and an output layer, as shown in FIG. 4. Each neuron of the convolution kernel in the convolution layer is locally connected to its input, and the pooling layer is introduced to extract the local maximum or average features of a certain layer, which effectively reduces parameters of the network and mines the local features, so that the convolutional neural network may converge quickly to obtain excellent performance.

RNN is a neural network that models sequential data, which has achieved remarkable results in the field of natural language processing applications, such as machine translation and speech recognition. The network memorizes information from past moments and uses it in the computation of the current output. That is, nodes between hidden layers are no longer unconnected but connected, and the input of the hidden layer includes not only the input layer but also the output of the hidden layer at the previous moment. Commonly used RNNs include structures such as long short-term memory (LSTM) and gated recurrent unit (GRU). FIG. 5 shows a basic LSTM unit structure, which may include a tanh activation function. Unlike RNN, which only considers the most recent state, the cell state of LSTM determines which states should be retained and which states should be forgotten, thus solving the defects of traditional RNNs in long-term memory.

To facilitate a proper understanding of the embodiments of the present application, the positioning technology related to the present application is described.

In traditional positioning methods, for different methods, a terminal device (UE) or a location management function (LMF) entity applies traditional algorithms, such as the Chan algorithm, Taylor expansion and other algorithms to estimate the location of the terminal device.

UE-based positioning method: a terminal directly estimates the location of a target UE. The terminal device estimates the location of the target UE using a traditional algorithm.

UE-assisted positioning method/LMF-based positioning method: a terminal reports a measurement result to an LMF entity, and the LMF entity estimates the location of a target UE based on the collected measurement result. The LMF side estimates the location of the target UE using a traditional algorithm.

5G radio access network node assisted (NG-RAN node assisted) positioning method: a base station reports a measurement result of a transmission reception point (TRP) to an LMF entity, and the LMF entity estimates the location of a target UE based on the collected measurement result. The LMF side estimates the location of the target UE using a traditional algorithm.

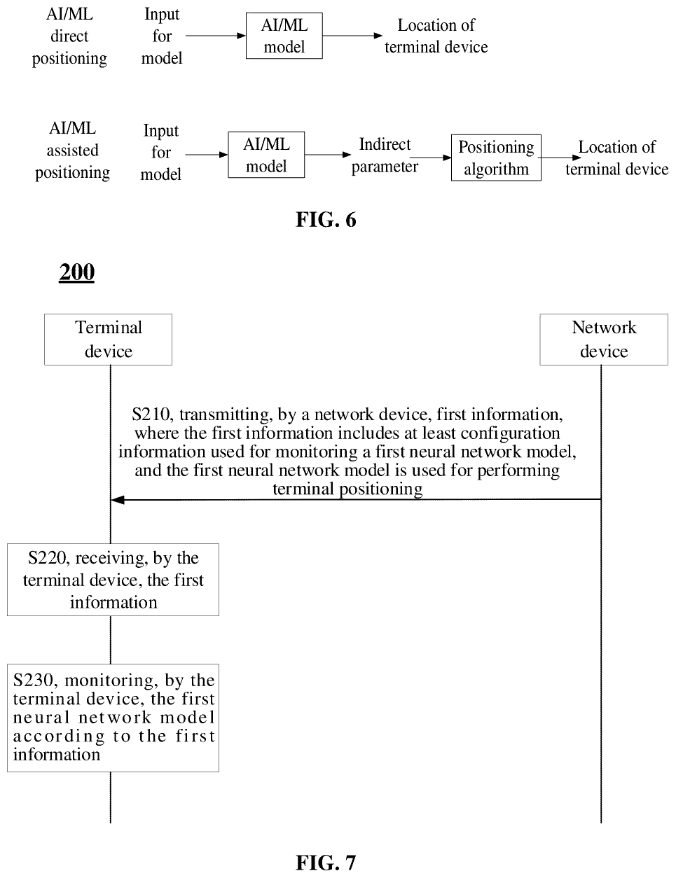

Artificial Intelligence (AI)/machine learning (ML) models may be combined with any positioning method replacing the traditional algorithms to estimate the location of terminal devices. The AI/ML model may be deployed on a UE side or on an LMF side, or on both the UE and LMF sides. The combination of AI/ML models and positioning methods may be divided into a direct positioning with an AI/ML model and an assisted positioning with an AI/ML model, as shown in FIG. 6.

To facilitate a proper understanding of the embodiments of the present application, the problems solved by the present application are described.

At the present stage, an AI/ML model may be combined with a positioning method to perform terminal positioning. For example, for a direct positioning with an AI/ML model, the location of a terminal device may be directly obtained through a trained AI/ML model. However, the positioning accuracy will be affected by the AI/ML model. For example, an AI/ML model 1 trained using data from a communication scenario 1 may not be suitable for a communication scenario 2. This will cause the positioning error of the terminal device to increase significantly in a case where the AI/ML model 1 is used for positioning in a communication scenario 2.

For the AI/ML model monitoring process, the terminal side needs to evaluate the performance of the currently running AI/ML model, and determine whether the AI/ML model needs to be updated based on the evaluation result. However, how to monitor AI/ML models is a problem that needs to be solved.

In light of the above problems, the present application proposes a model monitoring solution, whereby the terminal device may monitor a neural network model (i.e., an AI/ML model) used for terminal positioning, thereby ensuring the performance of the neural network model.

In the embodiments, a model monitoring method is provided, where the method includes:
receiving, by a terminal device, first information, where the first information includes at least configuration information used for monitoring a first neural network model, and the first neural network model is used for performing terminal positioning; and
monitoring, by the terminal device, the first neural network model according to the first information.

In some embodiments, where the configuration information used for monitoring the first neural network model includes configuration information of a reference signal used for monitoring the first neural network model.

In some embodiments, where the reference signal used for monitoring the first neural network model is a periodic reference signal or a reference signal with semi-persistent scheduling (SPS).

In some embodiments, where the reference signal used for monitoring the first neural network model is one of following: a downlink positioning reference signal (PRS), a sounding reference signal (SRS), a channel state information reference signal (CSI-RS), a synchronization signal block (SSB), or a demodulation reference signal (DMRS).

In some embodiments, where the first information is carried in a long term evolution positioning protocol (LPP) message transmitted by a location management function (LMF) entity, or the first information is carried in a radio resource control (RRC) signaling.

In some embodiments, where in a case where the reference signal used for monitoring the first neural network model is the downlink PRS, the first information is carried in an LPP message transmitted by an LMF entity; or in a case where the reference signal used for monitoring the first neural network model is one of the SRS, the CSI-RS, the SSB, or the DMRS, the first information is carried in the RRC signaling.

In some embodiments, where the configuration information used for monitoring the first neural network model includes at least one of following: a monitoring period, a monitoring start time, a monitoring end time, a monitoring time window, a type of a monitoring reference signal, a period and/or time slot offset of the monitoring reference signal, a number of monitoring times, or a monitoring timer.

In some embodiments, where before the terminal device receives the first information, the method further includes: transmitting, by the terminal device, second information, where the second information is used for requesting monitoring of the first neural network model.

In some embodiments, where in a case where the configuration information used for monitoring the first neural network model is a downlink PRS used for monitoring the first neural network model, the second information is transmitted using an on-demand PRS mechanism.

In some embodiments, where the second information includes identification information of a downlink PRS configuration used for monitoring the first neural network model.

In some embodiments, where the second information includes downlink PRS parameter configuration information used for monitoring the first neural network model.

In some embodiments, where the downlink PRS parameter configuration information used for monitoring the first neural network model includes at least one of following: a period of the PRS, a subcarrier spacing of the PRS, a cyclic prefix length of the PRS, a frequency domain resource bandwidth of the PRS, a frequency domain starting frequency location of a PRS resource, a frequency domain reference point A of the PRS, or a comb size of the PRS.

In some embodiments, where the second information includes at least one of following: a monitoring period, a monitoring start time, a monitoring end time, a monitoring time window, a type of a monitoring reference signal, a period and/or time slot offset of the monitoring reference signal, a number of monitoring times, or a monitoring timer.

In some embodiments, where before the terminal device receives the first information, the method further includes: transmitting, by the terminal device, third information, where the third information is used for requesting a reference signal configuration and/or reference signal measurement interval used for monitoring the first neural network model.

In some embodiments, where a monitoring behavior of the terminal device for the first neural network model is triggered by one of following: the terminal device, or a network device.

In some embodiments, where the network device includes at least one of following: an LMF entity, an access network device, or an access and mobility management function (AMF) entity.

In some embodiments, where the monitoring behavior of the terminal device for the first neural network model is triggered in a case where a first condition is met; where the first condition includes at least one of following that: the terminal device performs a cell handover, a degradation in quality of a radio link is detected, a beam failure recovery (BFR) occurs, or an uplink out-of-step occurs.

In some embodiments, where the configuration information used for monitoring the first neural network model includes the first condition.

In some embodiments, where monitoring, by the terminal device, the first neural network model according to the first information includes: monitoring, by the terminal device, the first neural network model within a first time window according to the first information.

In some embodiments, where the first time window is predefined, or the first time window is preconfigured, or the first time window is configured by the network device.

In some embodiments, where the first time window is configured periodically, or the first time window is configured non-periodically.

In some embodiments, where the configuration information used for monitoring the first neural network model includes configuration information of the first time window.

In some embodiments, where monitoring, by the terminal device, the first neural network model according to the first information includes:
in a case where a difference between an input parameter of the first neural network model and a verification parameter is greater than or equal to a first threshold, determining, by the terminal device, that the first neural network model is invalid; and/or
in a case where the difference between the input parameter of the first neural network model and the verification parameter is less than the first threshold, determining, by the terminal device, that the first neural network model is valid;
where a type of the input parameter of the first neural network model is the same as a type of the verification parameter.

In some embodiments, where monitoring, by the terminal device, the first neural network model according to the first information includes:
during monitoring of the first neural network model, in a case where a number of times that a difference between an input parameter of the first neural network model and a verification parameter is greater than or equal to a first threshold is greater than or equal to a second threshold, determining, by the terminal device, that the first neural network model is invalid; and/or
during monitoring of the first neural network model, in a case where the number of times that the difference between the input parameter of the first neural network model and the verification parameter is greater than or equal to the first threshold is less than the second threshold, determining, by the terminal device, that the first neural network model is valid;
where a type of the input parameter of the first neural network model is the same as a type of the verification parameter.

In some embodiments, where the verification parameter is obtained by inverse deduction based on a prediction result of the first neural network model.

In some embodiments, where the input parameter of the first neural network model includes at least one of following: a downlink time difference of arrival (DL TDOA), a reference signal received power (RSRP), a downlink reference signal time difference (DL RSTD), a time of arrival (TOA), a downlink angle of departure (DL AoD), an uplink time difference of arrival (UL TDOA), an uplink relative time of arrival (UL RTOA), or an uplink angle of arrival (UL AoA).

In some embodiments, where in a case where a method of the terminal positioning performed by the first neural network model is a DL TDOA positioning, the input parameter of the first neural network model includes at least one of following: the DL TDOA, the RSRP, the DL RSTD, or the TOA.

In some embodiments, where in a case where a method of the terminal positioning performed by the first neural network model is a DL AOD positioning, the input parameter of the first neural network model includes the DL AOD.

In some embodiments, where in a case where a method of the terminal positioning performed by the first neural network model is a UL TDOA positioning, the input parameter of the first neural network model includes at least one of following: the UL TDOA, the RSRP, or the UL RTOA.

In some embodiments, where in a case where a method of the terminal positioning performed by the first neural network model is a UL AOA positioning, the input parameter of the first neural network model includes the UL AOA.

In some embodiments, where the input parameter of the first neural network model is a parameter of the terminal device relative to a single transmission reception point (TRP), and the verification parameter is a verification parameter of the terminal device relative to the single TRP; or the input parameter of the first neural network model is a parameter of the terminal device relative to multiple TRPs, and the verification parameter is a verification parameter of the terminal device relative to the multiple TRPs.

In some embodiments, where in a case where the input parameter of the first neural network model is the parameter of the terminal device relative to the multiple TRPs, the difference between the input parameter of the first neural network model and the verification parameter being greater than or equal to the first threshold includes that: a difference between a parameter of the terminal device relative to part or all of the multiple TRPs and a verification parameter of the terminal device relative to the corresponding TRP(s) is greater than or equal to the first threshold; and/or in a case where the input parameter of the first neural network model is the parameter of the terminal device relative to the multiple TRPs, the difference between the input parameter of the first neural network model and the verification parameter being less than the first threshold includes that: the difference between the parameter of the terminal device relative to the part or all of the multiple TRPs and the verification parameter of the terminal device relative to the corresponding TRP(s) is less than the first threshold.

In some embodiments, where in a case where the terminal device determines that the first neural network model is invalid, the method further includes: transmitting, by the terminal device, fourth information, where the fourth information is used for requesting an update of the network model, or the fourth information is used for indicating that the first neural network model has been invalid, or the fourth information is used for requesting that the terminal positioning is to be implemented by another method.

In some embodiments, where the fourth information includes information of at least one artificial intelligence (AI)/machine learning (ML) model supported by the terminal device and having a same function as that implementable by the first neural network model.

In some embodiments, where the method further includes:
transmitting, by the terminal device, first capability information, where the first capability information includes type information of the AI/ML model supported by the terminal device.

In some embodiments, where the method further includes:
receiving, by the terminal device, fifth information, where the fifth information includes at least one of following: identification information of a second neural network model, configuration information of the second neural network model, or configuration information required for the second neural network model to perform online training; and the second neural network model is an AI/ML model having a same function as that implementable by the first neural network model; and
switching, by the terminal device, from the first neural network model to the second neural network model.

In some embodiments, where the method further includes:
implementing, by the terminal device, the function implementable by the first neural network model in another method within a first time duration; where a start time of the first time duration is a time when the terminal device determines that the first neural network model is invalid, and an end time of the first time duration is a time when the terminal device successfully switches to the second neural network model.

In the embodiments, a model monitoring method is provided, where the method includes:
transmitting, by a network device, first information, where the first information includes at least configuration information used for monitoring a first neural network model, and the first neural network model is used for performing terminal positioning; and the first information is used for a terminal device to monitor the first neural network model.

In some embodiments, where the configuration information used for monitoring the first neural network model includes configuration information of a reference signal used for monitoring the first neural network model.

In some embodiments, where the reference signal used for monitoring the first neural network model is a periodic reference signal or a reference signal with semi-persistent scheduling (SPS).

In some embodiments, where the reference signal used for monitoring the first neural network model is one of following: a downlink positioning reference signal (PRS), a sounding reference signal (SRS), a channel state information reference signal (CSI-RS), a synchronization signal block (SSB), or a demodulation reference signal (DMRS).

In some embodiments, where the first information is carried in a long term evolution positioning protocol (LPP) message transmitted by a location management function (LMF) entity, or the first information is carried in a radio resource control (RRC) signaling.

In some embodiments, where in a case where the reference signal used for monitoring the first neural network model is the downlink PRS, the first information is carried in an LPP message transmitted by an LMF entity; or in a case where the reference signal used for monitoring the first neural network model is one of the SRS, the CSI-RS, the SSB, or the DMRS, the first information is carried in the RRC signaling.

In some embodiments, where the configuration information used for monitoring the first neural network model includes at least one of following: a monitoring period, a monitoring start time, a monitoring end time, a monitoring time window, a type of a monitoring reference signal, a period and/or time slot offset of the monitoring reference signal, a number of monitoring times, or a monitoring timer.

In some embodiments, where before the network device transmits the first information, the method further includes: receiving, by the network device, second information, where the second information is used for requesting monitoring of the first neural network model, and the first information is determined based on the second information.

In some embodiments, where in a case where the configuration information used for monitoring the first neural network model is a downlink PRS used for monitoring the first neural network model, the second information is transmitted using an on-demand PRS mechanism.

In some embodiments, where the second information includes identification information of a downlink PRS configuration used for monitoring the first neural network model.

In some embodiments, where the second information includes downlink PRS parameter configuration information used for monitoring the first neural network model.

In some embodiments, where the downlink PRS parameter configuration information used for monitoring the first neural network model includes at least one of following: a period of the PRS, a subcarrier spacing of the PRS, a cyclic prefix length of the PRS, a frequency domain resource bandwidth of the PRS, a frequency domain starting frequency location of a PRS resource, a frequency domain reference point A of the PRS, or a comb size of the PRS.

In some embodiments, where the second information includes at least one of following: a monitoring period, a monitoring start time, a monitoring end time, a monitoring time window, a type of a monitoring reference signal, a period and/or time slot offset of the monitoring reference signal, a number of monitoring times, or a monitoring timer.

In some embodiments, where before the network device transmits the first information, the method further includes: receiving, by the network device, third information, where the third information is used for requesting a reference signal configuration and/or reference signal measurement interval used for monitoring the first neural network model, and the first information is determined based on the third information.

In some embodiments, where a monitoring behavior of the terminal device for the first neural network model is triggered by one of following: the terminal device, or the network device.

In some embodiments, where the network device includes at least one of following: an LMF entity, an access network device, or an access and mobility management function (AMF) entity.

In some embodiments, where the monitoring behavior of the terminal device for the first neural network model is triggered in a case where a first condition is met; where the first condition includes at least one of following that: the terminal device performs a cell handover, a degradation in quality of a radio link is detected, a beam failure recovery (BFR) occurs, or an uplink out-of-step occurs.

In some embodiments, where the configuration information used for monitoring the first neural network model includes the first condition.

In some embodiments, where the first information being used for the terminal device to monitor the first neural network model includes that: the first information is used for the terminal device to monitor the first neural network model within a first time window.

In some embodiments, where the first time window is predefined, or the first time window is preconfigured, or the first time window is configured by the network device.

In some embodiments, where the first time window is configured periodically, or the first time window is configured non-periodically.

In some embodiments, where the configuration information used for monitoring the first neural network model includes configuration information of the first time window.

In some embodiments, where the first information being used for the terminal device to monitor the first neural network model includes that:
in a case where a difference between an input parameter of the first neural network model and a verification parameter is greater than or equal to a first threshold, the first neural network model is invalid; and/or
in a case where the difference between the input parameter of the first neural network model and the verification parameter is less than the first threshold, the first neural network model is valid;
where a type of the input parameter of the first neural network model is the same as a type of the verification parameter.

In some embodiments, where the first information being used for the terminal device to monitor the first neural network model includes:
during monitoring of the first neural network model, in a case where a number of times that a difference between an input parameter of the first neural network model and a verification parameter is greater than or equal to a first threshold is greater than or equal to a second threshold, the first neural network model is invalid; and/or
during monitoring of the first neural network model, in a case where the number of times that the difference between the input parameter of the first neural network model and the verification parameter is greater than or equal to the first threshold is less than the second threshold, the first neural network model is valid;
where a type of the input parameter of the first neural network model is the same as a type of the verification parameter.

In some embodiments, where the verification parameter is obtained by inverse deduction based on a prediction result of the first neural network model.

In some embodiments, where the input parameter of the first neural network model includes at least one of following: a downlink time difference of arrival (DL TDOA), a reference signal received power (RSRP), a downlink reference signal time difference (DL RSTD), a time of arrival (TOA), a downlink angle of departure (DL AoD), an uplink time difference of arrival (UL TDOA), an uplink relative time of arrival (UL RTOA), or an uplink angle of arrival (UL AoA).

In some embodiments, where in a case where a method of the terminal positioning performed by the first neural network model is a DL TDOA positioning, the input parameter of the first neural network model includes at least one of following: the DL TDOA, the RSRP, the DL RSTD, or the TOA.

In some embodiments, where in a case where a method of the terminal positioning performed by the first neural network model is a DL AOD positioning, the input parameter of the first neural network model includes the DL AOD.

In some embodiments, where in a case where a method of the terminal positioning performed by the first neural network model is a UL TDOA positioning, the input parameter of the first neural network model includes at least one of following: the UL TDOA, the RSRP, or the UL RTOA.

In some embodiments, where in a case where a method of the terminal positioning performed by the first neural network model is a UL AOA positioning, the input parameter of the first neural network model includes the UL AOA.

In some embodiments, where the input parameter of the first neural network model is a parameter of the terminal device relative to a single transmission reception point (TRP), and the verification parameter is a verification parameter of the terminal device relative to the single TRP; or the input parameter of the first neural network model is a parameter of the terminal device relative to multiple TRPs, and the verification parameter is a verification parameter of the terminal device relative to the multiple TRPs.

In some embodiments, where in a case where the input parameter of the first neural network model is the parameter of the terminal device relative to the multiple TRPs, the difference between the input parameter of the first neural network model and the verification parameter being greater than or equal to the first threshold includes that: a difference between a parameter of the terminal device relative to part or all of the multiple TRPs and a verification parameter of the terminal device relative to the corresponding TRP(s) is greater than or equal to the first threshold; and/or in a case where the input parameter of the first neural network model is the parameter of the terminal device relative to the multiple TRPs, the difference between the input parameter of the first neural network model and the verification parameter being less than the first threshold includes that: the difference between the parameter of the terminal device relative to the part or all of the multiple TRPs and the verification parameter of the terminal device relative to the corresponding TRP(s) is less than the first threshold.

In some embodiments, where the method further includes:
receiving, by the network device, fourth information, where the fourth information is used for requesting an update of the network model, or the fourth information is used for indicating that the first neural network model has been invalid, or the fourth information is used for requesting that the terminal positioning is to be implemented by another method.

In some embodiments, where the fourth information includes information of at least one artificial intelligence (AI)/machine learning (ML) model supported by the terminal device and having a same function as that implementable by the first neural network model.

In some embodiments, where the method further includes:
receiving, by the network device, first capability information, where the first capability information includes type information of the AI/ML model supported by the terminal device.

In some embodiments, where the method further includes:
transmitting, by the network device, fifth information, where the fifth information includes at least one of following: identification information of a second neural network model, configuration information of the second neural network model, or configuration information required for the second neural network model to perform online training; the second neural network model is an AI/ML model having a same function as that implementable by the first neural network model; and the fifth information is used for the terminal device to switch from the first neural network model to the second neural network model.

In some embodiments, where the terminal device implements the function implementable by the first neural network model in another method within a first time duration; where a start time of the first time duration is a time when the terminal device determines that the first neural network model is invalid, and an end time of the first time duration is a time when the terminal device successfully switches to the second neural network model.

The technical solution of the present application will be described in detail below through some embodiments.

FIG. 7 is a schematic flowchart of a model monitoring method 200 in accordance with the embodiments of the present application. As shown in FIG. 7, the model monitoring method 200 may include at least part of the following contents:
S210, transmitting, by a network device, first information, where the first information includes at least configuration information used for monitoring a first neural network model, and the first neural network model is used for performing terminal positioning;
S220, receiving, by a terminal device, the first information; and
S230, monitoring, by the terminal device, the first neural network model according to the first information.

In the embodiments of the present application, the terminal device may monitor the first neural network model used for terminal positioning based on the configuration information used for monitoring the first neural network model, and may determine whether the first neural network model is valid based on a monitoring result, and request an update of the network model in a case where the first neural network model is invalid, thereby ensuring the performance of the neural network model used for terminal positioning.

In some embodiments, the first neural network model may be deployed on a terminal side and/or a network side, and the first neural network model is the above-mentioned AI/ML model.

For example, the first neural network model is deployed on the terminal side, which can be understood as a combination of the AI/ML model and a UE-based positioning method.

For another example, the first neural network model is deployed on an LMF side, which can be understood as a combination of the AI/ML model and a UE-assisted/LMF-based positioning method, or a combination of the AI/ML model and an NG-RAN node assisted positioning method.

The embodiments of the present application do not limit the model structure and model parameter of the first neural network model.

In some embodiments, a monitoring behavior of the terminal device for the first neural network model is triggered by one of the following:
the terminal device, or the network device.

In some embodiments, the network device includes but is not limited to at least one of the following: an LMF entity, an access network device, or an access and mobility management function (AMF) entity.

In some embodiments, the configuration information used for monitoring the first neural network model includes at least one of the following: a monitoring period, a monitoring start time, a monitoring end time, a monitoring time window, a type of a monitoring reference signal, a period and/or time slot offset of the monitoring reference signal, the number of monitoring times, or a monitoring timer. Here, the monitoring timer is to make the monitoring of the first neural network model during the time that the timer is in effect, or to stop making the monitoring of the first neural network model after the timer times out, or to start making the monitoring of the first neural network model after the timer times out.

In some embodiments, the configuration information used for monitoring the first neural network model includes configuration information of a reference signal used for monitoring the first neural network model. For example, the terminal device may measure the reference signal used for monitoring the first neural network model based on the configuration information of the reference signal used for monitoring the first neural network model, and evaluate the performance of the first neural network model based on a measurement result to determine whether the first neural network model is valid.

In some embodiments, the reference signal used for monitoring the first neural network model is a periodic reference signal or a reference signal with semi-persistent scheduling (SPS). That is, the terminal device may measure and monitor the first neural network model periodically, or the terminal device may measure and monitor the first neural network model semi-statically.

In some embodiments, the reference signal used for monitoring the first neural network model is one of the following:
a downlink positioning reference signal (PRS), a sounding reference signal (SRS), a channel state information reference signal (CSI-RS), a synchronization signal block (SSB), or a demodulation reference signal (DMRS).

Of course, the reference signal used for monitoring the first neural network model may be any of other reference signals, to which the present application is not limited.

In some embodiments, the first information is carried in a long term evolution positioning protocol (LPP) message transmitted by a location management function (LMF) entity, or the first information is carried in a radio resource control (RRC) signaling.

In some embodiments, in a case where the reference signal used for monitoring the first neural network model is a downlink PRS, the first information is carried in an LPP message transmitted by an LMF entity. For example, the LMF entity configures a periodic or semi-persistent downlink PRS used for monitoring the first neural network model through an LPP protocol.

As an example, for a positioning method that combines the UE-based positioning method with the AI network model, that is, for a positioning solution in which the terminal device directly estimates a location of a target UE through the first neural network model, the LMF entity configures the periodic or semi-persistent downlink PRS used for monitoring the first neural network model through the LPP protocol.

As another example, for a positioning method that combines the UE-assisted positioning method with the AI network model, that is, for a positioning solution in which the terminal device reports the measurement result to the LMF entity, and the LMF entity estimates the location of the target UE according to the collected measurement result and the first neural network model, the LMF entity configures the periodic or semi-persistent downlink PRS used for monitoring the first neural network model through the LPP protocol.

In some embodiments, in a case where the reference signal used for monitoring the first neural network model is one of an SRS, a CSI-RS, an SSB, or a DMRS, the first information is carried in an RRC signaling. For example, a gNB or TRP configures a periodic or semi-persistent SRS or CSI-RS or SSB or DM-RS reference signal used for monitoring the first neural network model through the RRC signaling,

As an example, for a positioning method that combines the NG-RAN node assisted positioning method with the AI network model, that is, for a positioning solution in which a base station reports the measurement result of the TRP to the LMF entity, and the LMF entity estimates the location of the target UE according to the collected measurement result and the first neural network model, the gNB or TRP configures the periodic or semi-persistent SRS or CSI-RS or SSB or DM-RS reference signal used for monitoring the first neural network model through the RRC signaling.

In some embodiments, the terminal device transmits second information, where the second information is used for requesting monitoring of the first neural network model. For example, the second information may be transmitted before the terminal device receives the first information. That is, after receiving the second information, the network device transmits the first information to the terminal device based on the second information.

In some embodiments, the second information includes at least one of the following: a monitoring period, a monitoring start time, a monitoring end time, a monitoring time window, a type of a monitoring reference signal, a period and/or time slot offset of the monitoring reference signal, the number of monitoring times, or a monitoring timer. That is, the terminal device may report some parameter configurations used for monitoring the first neural network model, where the parameter configurations may be recommended values of the terminal device so that the network device may refer to the relevant parameter when configuring configuration information used for monitoring the first neural network model.

In some embodiments, in a case where the reference signal used for monitoring the first neural network model is the downlink PRS, the second information is transmitted using an on-demand PRS mechanism.

For example, the terminal device triggers the monitoring of the first neural network model. For example, the terminal device, using the On-demand PRS mechanism, requests the LMF entity for the downlink PRS used for monitoring the first neural network model. The LMF entity transmits the on-demand PRS to the terminal device. The terminal device performs model monitoring and reports a model monitoring result.

In some embodiments, the second information includes identification information of a downlink PRS configuration used for monitoring the first neural network model.

Optionally, the second information is an on-demand PRS request. For example, the LMF entity preconfigures the downlink PRS configuration used for monitoring the first neural network model, and the terminal device carries an identification corresponding to the downlink PRS configuration used for monitoring the first neural network model in the on-demand PRS request.

In some embodiments, the second information includes downlink PRS parameter configuration information used for monitoring the first neural network model. That is, the terminal device may report the downlink PRS parameter configuration information used for monitoring the first neural network model, so as to notify the network device, or so that the network device may refer to the relevant parameter when configuring the configuration information of the downlink PRS used for monitoring the first neural network model.

In some embodiments, the downlink PRS parameter configuration information used for monitoring the first neural network model includes at least one of the following:
a period of the PRS, a subcarrier spacing of the PRS, a cyclic prefix length of the PRS, a frequency domain resource bandwidth of the PRS, a frequency domain starting frequency location of the PRS resource, a frequency domain reference point A of the PRS, or a comb size of the PRS.

For example, if the LMF entity does not provide the terminal device with the downlink PRS configuration used for monitoring the first neural network model, the terminal device may explicitly notify the LMF entity of the parameter configuration used for monitoring the first neural network model. As an example, the parameter configuration includes a PRS parameter and a corresponding recommended value, for example, one or more of parameters including the period of the PRS, the subcarrier spacing of the PRS, the cyclic prefix length of the PRS, the frequency domain resource bandwidth of the PRS, the frequency domain starting frequency location of the PRS resource, the frequency domain reference point A of the PRS signal, or the comb size of the PRS signal.

In some embodiments, the LMF entity triggers monitoring of the first neural network model. For example, the LMF entity may configure a PRS reference signal for the terminal device to be used for monitoring the first neural network model according to the measurement result reported by the terminal device.

In some embodiments, the terminal device transmits third information, where the third information is used for requesting a reference signal configuration and/or reference signal measurement interval used for monitoring the first neural network model.

As an example, the terminal device requests the network device for a PRS configuration and/or PRS measurement interval used for monitoring the first neural network model through a media access control-control element (MAC CE) signaling. The network device may configure PRS configuration information used for monitoring the first neural network model for the terminal device through MAC CE, or the network device may configure SRS configuration information used for monitoring the first neural network model through DCI.

In some embodiments, the monitoring behavior of the terminal device for the first neural network model is triggered in a case where a first condition is met;
where the first condition includes at least one of the following that: the terminal device performs a cell handover, a degradation in the quality of a radio link is detected, a beam failure recovery (BFR) occurs, or an uplink out-of-step occurs.

In some embodiments, the configuration information used for monitoring the first neural network model includes the first condition.

In some embodiments, the above S230 may include:
monitoring, by the terminal device, the first neural network model within a first time window according to the first information.

In some embodiments, the first time window is predefined, or the first time window is preconfigured, or the first time window is configured by the network device.

In some embodiments, the first time window is configured periodically, or the first time window is configured non-periodically.

In some embodiments, a configuration granularity of the first time window may be milliseconds, seconds, time slots, mini-time slots, symbols, or the like.

In some embodiments, the configuration information used for monitoring the first neural network model includes configuration information of the first time window.

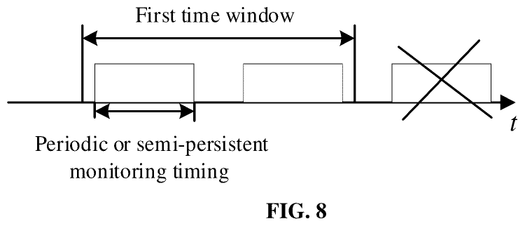

As an example, as shown in FIG. 8, the terminal device monitors the first neural network model at periodic or semi-persistent monitoring timing within the first time window, and does not perform monitoring at periodic or semi-persistent monitoring timing outside the first time window.

Therefore, in the embodiments of the present application, the first neural network model may be monitored in different methods to ensure the positioning performance of the first neural network model. The periodic monitoring/semi-static monitoring method, the triggered monitoring, and the monitoring method based on the first time window may be configured in different scenarios, or configured simultaneously, so as to ensure the performance of the first neural network model.

In some embodiments, different AI positioning methods may use different metrics for model monitoring.

In some embodiments, the above S230 may include:
in a case where a difference between an input parameter of the first neural network model and a verification parameter is greater than or equal to a first threshold, determining, by the terminal device, that the first neural network model is invalid; and/or
in a case where the difference between the input parameter of the first neural network model and the verification parameter is less than the first threshold, determining, by the terminal device, that the first neural network model is valid;
where a type of the input parameter of the first neural network model is the same as a type of the verification parameter.

It should be noted that the invalid of the first neural network model can be understood as the first neural network model being unsuitable for the current scenario.

In some embodiments, the verification parameter is obtained by inverse deduction based on a prediction result of the first neural network model.

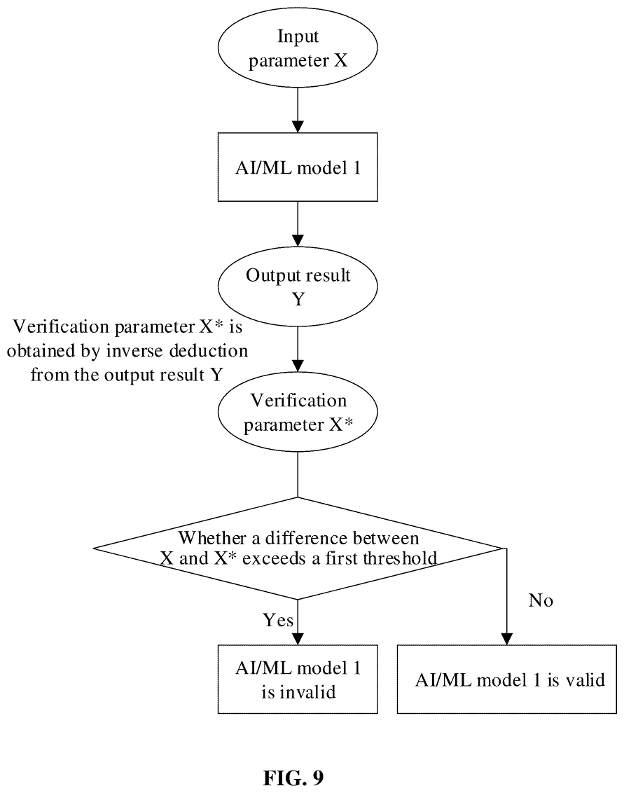

As an example, as shown in FIG. 9, the first neural network model is denoted as an AI/ML model 1, an input parameter of the AI model 1 is X, an output result (i.e., the prediction result) of the AI/ML model 1 is Y, and the verification parameter is X*, where X* is obtained by inverse deduction from Y. As shown in FIG. 9, the terminal device determines whether a difference between X and X* exceeds the first threshold, if so, the AI/ML model 1 is invalid, if not, the AI/ML model 1 is valid.

In some embodiments, the first threshold may be preconfigured, or the first threshold may be agreed upon by a protocol, or the first threshold may be configured by the network device.

In some embodiments, the above S230 may include:
during monitoring of the first neural network model, in a case where the number of times that a difference between an input parameter of the first neural network model and a verification parameter is greater than or equal to a first threshold is greater than or equal to a second threshold, determining, by the terminal device, that the first neural network model is invalid; and/or
during monitoring of the first neural network model, in a case where the number of times that the difference between the input parameter of the first neural network model and the verification parameter is greater than or equal to the first threshold is less than the second threshold, determining, by the terminal device, that the first neural network model is valid;
where the type of the input parameter of the first neural network model is the same as the type of the verification parameter.

For example, the input parameter of the first neural network model is a numerical value, the verification parameter is also a numerical value, the first threshold is also a numerical value, and an output result of the first neural network model is a location of a target terminal.

For another example, the input parameter of the first neural network model is a vector, the verification parameter is also a vector, the first threshold is also a vector, and the output result of the first neural network model is the location of the target terminal.

For another example, the input parameter of the first neural network model is an angle, the verification parameter is also an angle, the first threshold is also an angle, and the output result of the first neural network model is the location of the target terminal.

For another example, the input parameter of the first neural network model is a distribution function, the verification parameter is also a distribution function, the first threshold is also a distribution function, and the output result of the first neural network model is the location of the target terminal.

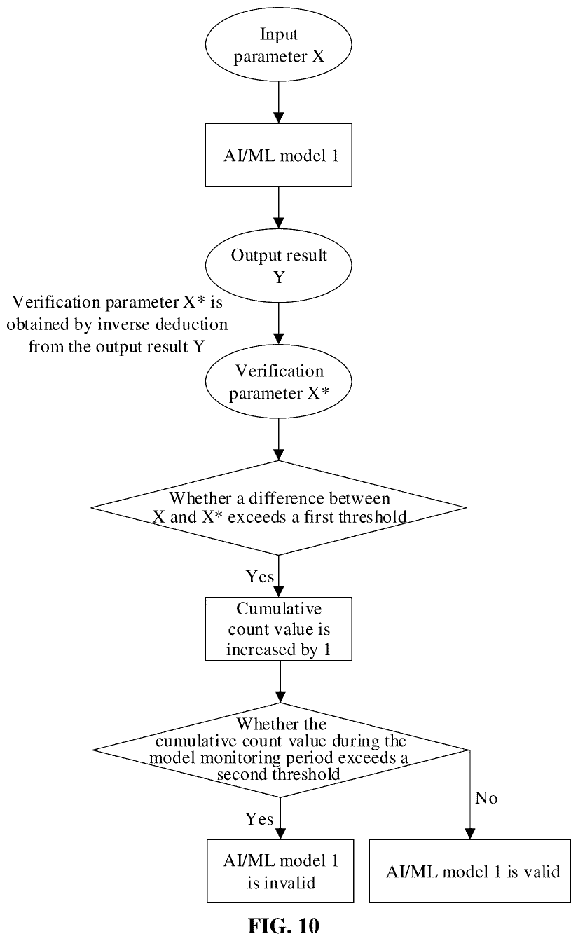

As an example, as shown in FIG. 10, the first neural network model is denoted as an AI/ML model 1, an input parameter of the AI model 1 is X, an output result (i.e., the prediction result) of the AI/ML model 1 is Y, and the verification parameter is X*, where X* is obtained by inverse deduction from Y. As shown in FIG. 10, the terminal device determines whether the difference between X and X* exceeds the first threshold, if so, a cumulative count value is increased by 1; and the terminal device determines whether the cumulative count value during the model monitoring period exceeds the second threshold, if so, the AI/ML model 1 is invalid, if not, the AI/ML model 1 is valid.

In some embodiments, the second threshold may be preconfigured, or the second threshold may be agreed upon by a protocol, or the second threshold may be configured by the network device.

In some embodiments, the input parameter of the first neural network model is a parameter of the terminal device relative to a single TRP, and the verification parameter is a verification parameter of the terminal device relative to the single TRP.

In some embodiments, the input parameter of the first neural network model is a parameter of the terminal device relative to multiple TRPs, and the verification parameter is a verification parameter of the terminal device relative to the multiple TRPs.

In some embodiments, in a case where the input parameter of the first neural network model is the parameter of the terminal device relative to the multiple TRPs, the difference between the input parameter of the first neural network model and the verification parameter being greater than or equal to the first threshold includes that:
a difference between a parameter of the terminal device relative to part or all of the multiple TRPs and a verification parameter of the terminal device relative to the corresponding TRP(s) is greater than or equal to the first threshold.

In some embodiments, in a case where the input parameter of the first neural network model is the parameter of the terminal device relative to the multiple TRPs, the difference between the input parameter of the first neural network model and the verification parameter being less than the first threshold includes that:
a difference between a parameter of the terminal device relative to part or all of the multiple TRPs and a verification parameter of the terminal device relative to the corresponding TRP(s) is less than the first threshold.

In some embodiments, the input parameter of the first neural network model includes at least one of the following: a downlink time difference of arrival (DL TDOA), a reference signal received power (RSRP), a downlink reference signal time difference (DL RSTD), a time of arrival (TOA), a downlink angle of departure (DL AoD), an uplink time difference of arrival (UL TDOA), an uplink relative time of arrival (UL RTOA), or an uplink angle of arrival (UL AoA).

In some embodiments, in a case where the terminal positioning method performed by the first neural network model is a DL TDOA positioning, the input parameter X of the first neural network model includes at least one of the following: the DL TDOA, the RSRP, the DL RSTD, or the TOA. As an example, the input parameter X of the first neural network model may be the DL TDOA, the RSRP, the DL RSTD, the TOA, or the like. The output result Y of the first neural network model is the location of the terminal device. The verification parameter X* is a corresponding result obtained by inverse deduction from the output result Y. X* corresponds to X and may be a DL TDOA, an RSRP, a DL RSTD, a TOA, or the like.

Optionally, the input parameter X of the first neural network model may be a combination of the DL TDOA and the RSRP, or a combination of the DL RSTD and the RSRP, or a combination of the TOA and the RSRP. Correspondingly, the verification parameter X* is a combination of the DL TDOA and the RSRP, or a combination of the DL RSTD and the RSRP, or a combination of the TOA and the RSRP, obtained by inverse deduction from the output result Y.

Optionally, the input parameter X of the first neural network model may be for the single TRP or for the multiple TRPs.

Optionally, in a case where the input parameter X of the first neural network model is for the multiple TRPs, the output result Y is still the location of the terminal device, and the verification parameter X* is for the multiple TRPs. For example, if the number of the TRPs is n (n is greater than 1), the input parameter is DL TDOAs of the terminal device relative to the n TRPs, RSRPs of the terminal device relative to the n TRPs, DL RSTDs of the terminal device relative to the n TRPs, and TOAs of the terminal device relative to the n TRPs; a number of a DL TDOA, an RSRP, a DL RSTD, and a TOA corresponding to each TRP may be greater than 1. The verification parameter X* is DL TDOAs of the terminal device relative to the n TRPs, RSRPs of the terminal device relative to the n TRPs, DL RSTDs of the terminal device relative to the n TRPs, and TOAs of the terminal device relative to the n TRPs, which are obtained by inverse deduction from the output result Y. In this case, “whether a difference between X and X* exceeds a first threshold” in FIGS. 9 and 10 is for the same TRP, and can also be replaced by “whether a difference between X and X* corresponding to m of the n TRPs exceeds the threshold”, where m is less than or equal to n.

In some embodiments, in a case where the terminal positioning method performed by the first neural network model is a DL AOD positioning, the input parameter of the first neural network model includes the DL AOD. As an example, the input parameter X of the first neural network model may be the DL AoD of the terminal device for the network device (such as TRP). The output result Y is the location of the terminal device. The verification parameter X* is a corresponding result obtained by inverse deduction from the output result Y, and X* corresponds to X and may be a DL AoD.

For example, the input parameter X may be for the single TRP or for the multiple TRPs. In a case where the input parameter X is for the multiple TRPs, the output result Y is still the location of the terminal device, and the verification parameter X* is for the multiple TRPs. For example, if the number of the TRPs is n (n is greater than 1), the input parameter X is DL AoDs of the terminal device relative to the n TRPs. In this case, “whether a difference between X and X* exceeds a first threshold” in FIGS. 9 and 10 is for the same TRP, and can also be replaced by “whether a difference between X and X* corresponding to m of the n TRPs exceeds the threshold”, where m is less than or equal to n. It should be understood that a number of a DL AoD corresponding to each TRP may be greater than 1.

In some embodiments, in a case where the terminal positioning method performed by the first neural network model is a UL TDOA positioning, the input parameter of the first neural network model includes at least one of the following: the UL TDOA, the RSRP, or the UL RTOA. As an example, a combination of the NG-RAN node assisted positioning method and the AI/ML method, can also be understood as the AI/ML model being deployed on the LMF side.

In a case where the UE-based positioning method is the UL TDOA positioning method, the input parameter X is the UL TDOA, the RSRP, the UL RTOA, etc., of the terminal device for the network device (such as TRP). The output result Y is the location of the terminal device. The verification parameter X* is a corresponding result obtained by inverse deduction from the output result Y. X* corresponds to X and may be the UL TDOA, the RSRP, the UL RTOA, or the like.

Optionally, the input parameter X may be a combination of the UL TDOA and the RSRP, or a combination of the UL RTOA and the RSRP. Correspondingly, the verification parameter X* is a combination of the UL TDOA and the RSRP, or a combination of the UL RTOA and the RSRP, obtained by inverse deduction from the output result Y.

Optionally, the input parameter X may be for the single TRP or for the multiple TRPs. In a case where the input parameter X is for the multiple TRPs, the output result Y is still the location of the terminal device, and the verification parameter X* is for the multiple TRPs. For example, if the number of TRPs is n (n is greater than 1), the input parameter X is UL TDOAs of the terminal device relative to the n TRPs, RSRPs of the terminal device relative to the n TRPs, and UL RTOAs of the terminal device relative to the n TRPs; it should be understood that the number of each of a UL TDOA, an RSRP, and a UL RTOA corresponding to each TRP may be greater than 1. The verification parameter X* is UL TDOAs of the terminal device relative to the n TRPs, RSRPs of the terminal device relative to the n TRPs, and UL RTOAs of the terminal device relative to the n TRPs, which are obtained by inverse deduction from the output result Y. In this case, “whether a difference between X and X* exceeds a first threshold” in FIGS. 9 and 10 is for the same TRP, and can also be replaced by “whether a difference between X and X* corresponding to m of the n TRPs exceeds the threshold”, where m is less than or equal to n.

In some embodiments, in a case where the terminal positioning method performed by the first neural network model is a UL AOA positioning, the input parameter of the first neural network model includes the UL AOA.

As an example, in a case where the UE-based positioning method is the UL AoA positioning method, the input parameter X is an uplink angle of arrival of the terminal device for the network device (such as TRP), such as an azimuth angle and/or a zenith angle. The output result Y is the location of the terminal device. The verification parameter X* is the corresponding result obtained by inverse deduction from the output result Y. X* corresponds to X and may be an uplink angle of arrival of the terminal device for the network device, such as an azimuth angle and/or a zenith angle.

For example, the input parameter X may be for the single TRP or for the multiple TRPs. In a case where the input parameter X is for the multiple TRPs, the output result Y is still the location of the terminal device, and the verification parameter X* is for the multiple TRPs. For example, if the number of the TRPs is n (n is greater than 1), the input parameter X is AoAs of the terminal device relative to the n TRPs. In this case, “whether a difference between X and X* exceeds a first threshold” in FIGS. 9 and 10 is for the same TRP, and can also be replaced by “whether a difference between X and X* corresponding to m of the n TRPs exceeds the threshold”, where m is less than or equal to n. It should be understood that a number of an AoA corresponding to each TRP may be greater than 1.

Therefore, in the embodiments of the present application, if the first neural network model is no longer applicable to the current communication scenario, the problem will be detected in time through the performance monitoring of the first neural network model. Because the accuracy of the positioning error cannot be directly obtained in actual deployment scenarios, the embodiments give metrics for performance monitoring of different positioning methods.

In some embodiments, in a case where the terminal device determines that the first neural network model is invalid, the terminal device transmits fourth information, where the fourth information is used for requesting an update of the network model, or the fourth information is used for indicating that the first neural network model has been invalid, or the fourth information is used for requesting that terminal positioning is to be implemented by another method.

As an example, the another method for implementing terminal positioning is to fall back to a traditional positioning method to implement terminal positioning.

In some embodiments, the fourth information includes information of at least one AI/ML model supported by the terminal device and having the same function as that implementable by the first neural network model.

In some embodiments, the terminal device transmits first capability information, where the first capability information includes type information of the AI/ML model supported by the terminal device.

In some embodiments, the terminal device receives fifth information, where the fifth information includes at least one of the following: identification information of a second neural network model, configuration information of the second neural network model, or configuration information required for the second neural network model to perform online training. The second neural network model is an AI/ML model having the same function as that implementable by the first neural network model, where the identification information of the second neural network model includes an index or identification (ID) of the second neural network model.

The terminal device switches from the first neural network model to the second neural network model.

In some embodiments, the terminal device implements the function implementable by the first neural network model in another method within a first time duration; where a start time of the first time duration is a time when the terminal device determines that the first neural network model is invalid, and an end time of the first time duration is a time when the terminal device successfully switches to the second neural network model. For example, the another method may be a traditional positioning method.

In some embodiments, it is assumed that the first neural network model is an AI/ML model 1, and the AI/ML model 1 is a trained AI/ML model. If a result of an AI/ML model monitoring is that the AI/ML model 1 needs to be updated to an AI/ML model 2, the AI/ML model 2 is an AI/ML model in a set of AI/ML models that have been trained (offline training) (called type 1), or the AI/ML model 2 is a new AI/ML model trained online based on a training set of the AI/ML model 1 (fine-tuning, a new model obtained by updating part of the data in the AI/ML model 1, called type 2), or the AI/ML model 2 is a new AI/ML model trained online (retraining a new dataset, called type 3), or the AI/ML model 2 is another new AI/ML model trained online (in which the AI/ML model structure remains unchanged, only weights are updated, called type 4).

In some embodiments, the first capability information includes one or more of the type 1, the type 2, the type 3, or the type 4.

In some embodiments, steps of updating the AI model include part or all of the following steps.

In Step 1, a UE transmits a model update request to a network device.

In Step 2, the UE transmits a type (the types 1, 2, 3, 4) of the supported AI/ML model 2 to the network device (which may be one of the first capability information).

In Step 3-1, if the AI/ML model 2 is the type 1, the UE receives a configuration of the AI/ML model 2 or an index of the AI/ML model 2 in a set of AI/ML models, transmitted by the network device.

In Step 3-2, the UE receives auxiliary information related to an AI/ML model update transmitted by the network device, where the auxiliary information includes configuration information required for online training in a case where the AI/ML model 2 is the type 2, the type 3, or the type 4.

In Step 4, the UE performs the online training based on Step 3-2.

In Step 5, the AI/ML model is updated to the AI/ML model 2.

It should be noted that after the UE transmits the AI/ML model update request, during the period until the AI/ML model is updated to the AI/ML model 2, it falls back to the traditional positioning method. The fallback mechanism can avoid positioning errors caused by inaccurate AI/ML models.

Therefore, in the embodiments of the present application, the terminal device may monitor the first neural network model used for terminal positioning based on the configuration information used for monitoring the first neural network model, and may determine whether the first neural network model is valid based on the monitoring result, and request an update of the network model in a case where the first neural network model is invalid, thereby ensuring the performance of the neural network model used for terminal positioning.

The method embodiments of the present application have been described in detail above with reference to FIGS. 7 to 10. The device embodiments of the present application will be described in detail below with reference to FIGS. 11 to 15. It should be understood that the device embodiments and the method embodiments correspond to each other, and similar descriptions can refer to the method embodiments.

FIG. 11 illustrates a schematic block diagram of a terminal device 300 in accordance with the embodiments of the present application. As shown in FIG. 11, the terminal device 300 includes:
a communication unit 310, configured to receive first information, where the first information includes at least configuration information used for monitoring a first neural network model, and the first neural network model is used for performing terminal positioning; and
a processing unit 320, configured to monitor the first neural network model according to the first information.

In some embodiments, the configuration information used for monitoring the first neural network model includes configuration information of a reference signal used for monitoring the first neural network model.

In some embodiments, the reference signal used for monitoring the first neural network model is a periodic reference signal or a reference signal with semi-persistent scheduling (SPS).

In some embodiments, the reference signal used for monitoring the first neural network model is one of the following:
a downlink positioning reference signal (PRS), a sounding reference signal (SRS), a channel state information reference signal (CSI-RS), a synchronization signal block (SSB), or a demodulation reference signal (DMRS).

In some embodiments, the first information is carried in a long term evolution positioning protocol (LPP) message transmitted by a location management function (LMF) entity, or the first information is carried in a radio resource control (RRC) signaling.

In some embodiments, in a case where the reference signal used for monitoring the first neural network model is a downlink PRS, the first information is carried in an LPP message transmitted by an LMF entity; or
in a case where the reference signal used for monitoring the first neural network model is one of an SRS, a CSI-RS, an SSB, or a DMRS, the first information is carried in an RRC signaling.

In some embodiments, the configuration information used for monitoring the first neural network model includes at least one of the following:
a monitoring period, a monitoring start time, a monitoring end time, a monitoring time window, a type of a monitoring reference signal, a period and/or time slot offset of the monitoring reference signal, the number of monitoring times, or a monitoring timer.

In some embodiments, before the terminal device receives the first information, the communication unit 310 is further configured to transmit second information, where the second information is used for requesting monitoring of the first neural network model.

In some embodiments, in a case where the configuration information used for monitoring the first neural network model is the downlink PRS used for monitoring the first neural network model, the second information is transmitted using an on-demand PRS mechanism.

In some embodiments, the second information includes identification information of a downlink PRS configuration used for monitoring the first neural network model.

In some embodiments, the second information includes downlink PRS parameter configuration information used for monitoring the first neural network model.

In some embodiments, the downlink PRS parameter configuration information used for monitoring the first neural network model includes at least one of the following:
a period of the PRS, a subcarrier spacing of the PRS, a cyclic prefix length of the PRS, a frequency domain resource bandwidth of the PRS, a frequency domain starting frequency location of the PRS resource, a frequency domain reference point A of the PRS, or a comb size of the PRS.

In some embodiments, the second information includes at least one of the following:
a monitoring period, a monitoring start time, a monitoring end time, a monitoring time window, a type of a monitoring reference signal, a period and/or time slot offset of the monitoring reference signal, the number of monitoring times, or a monitoring timer.

In some embodiments, before the terminal device receives the first information, the communication unit 310 is further configured to transmit third information, where the third information is used for requesting a reference signal configuration and/or reference signal measurement interval used for monitoring the first neural network model.

In some embodiments, a monitoring behavior of the terminal device for the first neural network model is triggered by one of the following:
the terminal device, or a network device.

In some embodiments, the network device includes at least one of the following:
an LMF entity, an access network device, or an access and mobility management function (AMF) entity.

In some embodiments, the monitoring behavior of the terminal device for the first neural network model is triggered in a case where a first condition is met;
where the first condition includes at least one of the following that: the terminal device performs a cell handover, a degradation in the quality of a radio link is detected, a beam failure recovery (BFR) occurs, or an uplink out-of-step occurs.

In some embodiments, the configuration information used for monitoring the first neural network model includes the first condition.

In some embodiments, the processing unit 320 is configured to:
monitor the first neural network model within a first time window according to the first information.

In some embodiments, the first time window is predefined, or the first time window is preconfigured, or the first time window is configured by the network device.

In some embodiments, the first time window is configured periodically, or the first time window is configured non-periodically.

In some embodiments, the configuration information used for monitoring the first neural network model includes configuration information of the first time window.

In some embodiments, the processing unit 320 is configured to:
in a case where a difference between an input parameter of the first neural network model and a verification parameter is greater than or equal to a first threshold, determine that the first neural network model is invalid; and/or
in a case where the difference between the input parameter of the first neural network model and the verification parameter is less than the first threshold, determine that the first neural network model is valid;
where a type of the input parameter of the first neural network model is the same as a type of the verification parameter.

In some embodiments, the processing unit 320 is configured to:
during monitoring of the first neural network model, in a case where the number of times that a difference between an input parameter of the first neural network model and a verification parameter is greater than or equal to a first threshold is greater than or equal to a second threshold, determine that the first neural network model is invalid; and/or
during monitoring of the first neural network model, in a case where the number of times that the difference between the input parameter of the first neural network model and the verification parameter is greater than or equal to the first threshold is less than the second threshold, determine that the first neural network model is valid;
where a type of the input parameter of the first neural network model is the same as a type of the verification parameter.

In some embodiments, the verification parameter is obtained by inverse deduction based on a prediction result of the first neural network model.

In some embodiments, the input parameter of the first neural network model includes at least one of the following: a downlink time difference of arrival (DL TDOA), a reference signal received power (RSRP), a downlink reference signal time difference (DL RSTD), a time of arrival (TOA), a downlink angle of departure (DL AoD), an uplink time difference of arrival (UL TDOA), an uplink relative time of arrival (UL RTOA), or an uplink angle of arrival (UL AoA).

In some embodiments, in a case where the terminal positioning method performed by the first neural network model is a DL TDOA positioning, the input parameter of the first neural network model includes at least one of the following: the DL TDOA, the RSRP, the DL RSTD, or the TOA.

In some embodiments, in a case where the terminal positioning method performed by the first neural network model is a DL AOD positioning, the input parameter of the first neural network model includes the DL AOD.

In some embodiments, in a case where the terminal positioning method performed by the first neural network model is a UL TDOA positioning, the input parameter of the first neural network model includes at least one of the following: the UL TDOA, the RSRP, or the UL RTOA.

In some embodiments, in a case where the terminal positioning method performed by the first neural network model is a UL AOA positioning, the input parameter of the first neural network model includes the UL AOA.

In some embodiments, the input parameter of the first neural network model is a parameter of the terminal device relative to a single transmission reception point (TRP), and the verification parameter is a verification parameter of the terminal device relative to the single TRP; or
the input parameter of the first neural network model is a parameter of the terminal device relative to multiple TRPs, and the verification parameter is a verification parameter of the terminal device relative to the multiple TRPs.

In some embodiments, in a case where the input parameter of the first neural network model is the parameter of the terminal device relative to the multiple TRPs, the difference between the input parameter of the first neural network model and the verification parameter being greater than or equal to the first threshold includes that: a difference between a parameter of the terminal device relative to part or all of the multiple TRPs and a verification parameter of the terminal device relative to the corresponding TRP(s) is greater than or equal to the first threshold; and/or
in a case where the input parameter of the first neural network model is the parameter of the terminal device relative to the multiple TRPs, the difference between the input parameter of the first neural network model and the verification parameter being less than the first threshold includes that: the difference between the parameter of the terminal device relative to the part or all of the multiple TRPs and the verification parameter of the terminal device relative to the corresponding TRP(s) is less than the first threshold.

In some embodiments, in a case where the terminal device determines that the first neural network model is invalid, the communication unit 310 is further configured to transmit fourth information, where the fourth information is used for requesting an update of the network model, or the fourth information is used for indicating that the first neural network model has been invalid, or the fourth information is used for requesting that terminal positioning is to be implemented by another method.

In some embodiments, the fourth information includes information of at least one artificial intelligence (AI)/machine learning (ML) model supported by the terminal device and having the same function as that implementable by the first neural network model.

In some embodiments, the communication unit 310 is further configured to transmit first capability information, where the first capability information includes type information of the AI/ML model supported by the terminal device.

In some embodiments, the communication unit 310 is further configured to receive fifth information, where the fifth information includes at least one of the following: identification information of a second neural network model, configuration information of the second neural network model, or configuration information required for the second neural network model to perform online training; the second neural network model is a network model having the same function as that implementable by the first neural network model; and
the processing unit 320 is further configured to switch from the first neural network model to the second neural network model.

In some embodiments, the processing unit 320 is further configured to implement the function implementable by the first neural network model in another method within a first time duration;
where a start time of the first time duration is a time when the terminal device determines that the first neural network model is invalid, and an end time of the first time duration is a time when the terminal device successfully switches to the second neural network model.

In some embodiments, the communication unit mentioned above may be a communication interface or a transceiver, or an input/output interface of a communication chip or a system on chip; and the processing unit mentioned above may be one or more processors.

It should be understood that the terminal device 300 in accordance with the embodiments of the present application may correspond to the terminal device in the method embodiments of the present application, and the above-mentioned and other operations and/or functions of each unit in the terminal device 300 are respectively for implementing a corresponding procedure of the terminal device in the method 200 shown in FIG. 7, which will not be repeated here for brevity.

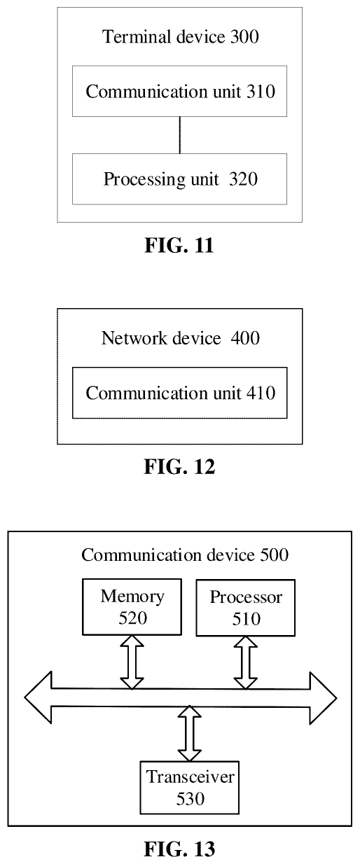

FIG. 12 illustrates a schematic block diagram of a network device 400 in accordance with the embodiments of the present application. As shown in FIG. 12, the network device 400 includes:
a communication unit 410, configured to transmit first information, where the first information includes at least configuration information used for monitoring a first neural network model, and the first neural network model is used for performing terminal positioning; and the first information is used for a terminal device to monitor the first neural network model.

In some embodiments, the configuration information used for monitoring the first neural network model includes configuration information of a reference signal used for monitoring the first neural network model.

In some embodiments, the reference signal used for monitoring the first neural network model is a periodic reference signal or a reference signal with semi-persistent scheduling (SPS).

In some embodiments, the reference signal used for monitoring the first neural network model is one of the following:
a downlink positioning reference signal (PRS), a sounding reference signal (SRS), a channel state information reference signal (CSI-RS), a synchronization signal block (SSB), or a demodulation reference signal (DMRS).

In some embodiments, the first information is carried in a long term evolution positioning protocol (LPP) message transmitted by a location management function (LMF) entity, or the first information is carried in a radio resource control (RRC) signaling.

In some embodiments, in a case where the reference signal used for monitoring the first neural network model is a downlink PRS, the first information is carried in an LPP message transmitted by an LMF entity; or
in a case where the reference signal used for monitoring the first neural network model is one of an SRS, a CSI-RS, an SSB, or a DMRS, the first information is carried in an RRC signaling.

In some embodiments, the configuration information used for monitoring the first neural network model includes at least one of the following:
a monitoring period, a monitoring start time, a monitoring end time, a monitoring time window, a type of a monitoring reference signal, a period and/or time slot offset of the monitoring reference signal, the number of monitoring times, or a monitoring timer.

In some embodiments, before the network device transmits the first information, the communication unit 410 is further configured to receive second information, where the second information is used for requesting monitoring of the first neural network model, and the first information is determined based on the second information.

In some embodiments, in a case where the configuration information used for monitoring the first neural network model is the downlink PRS used for monitoring the first neural network model, the second information is transmitted using an on-demand PRS mechanism.

In some embodiments, the second information includes identification information of a downlink PRS configuration used for monitoring the first neural network model.

In some embodiments, the second information includes downlink PRS parameter configuration information used for monitoring the first neural network model.

In some embodiments, the downlink PRS parameter configuration information used for monitoring the first neural network model includes at least one of the following:
a period of the PRS, a subcarrier spacing of the PRS, a cyclic prefix length of the PRS, a frequency domain resource bandwidth of the PRS, a frequency domain starting frequency location of the PRS resource, a frequency domain reference point A of the PRS, or a comb size of the PRS.

In some embodiments, the second information includes at least one of the following:
a monitoring period, a monitoring start time, a monitoring end time, a monitoring time window, a type of a monitoring reference signal, a period and/or time slot offset of the monitoring reference signal, the number of monitoring times, or a monitoring timer.

In some embodiments, before the network device transmits the first information, the communication unit 410 is further configured to receive third information, where the third information is used for requesting a reference signal configuration and/or reference signal measurement interval used for monitoring the first neural network model, and the first information is determined based on the third information.

In some embodiments, a monitoring behavior of the terminal device for the first neural network model is triggered by one of the following:
the terminal device, or the network device.

In some embodiments, the network device includes at least one of the following:
an LMF entity, an access network device, or an access and mobility management function (AMF) entity.

In some embodiments, the monitoring behavior of the terminal device for the first neural network model is triggered in a case where a first condition is met;
where the first condition includes at least one of the following that: the terminal device performs a cell handover, a degradation in the quality of a radio link is detected, a beam failure recovery (BFR) occurs, or an uplink out-of-step occurs.

In some embodiments, the configuration information used for monitoring the first neural network model includes the first condition.

In some embodiments, the first information being used for the terminal device to monitor the first neural network model includes that:
the first information is used for the terminal device to monitor the first neural network model within a first time window.

In some embodiments, the first time window is predefined, or the first time window is preconfigured, or the first time window is configured by the network device.

In some embodiments, the first time window is configured periodically, or the first time window is configured non-periodically.

In some embodiments, the configuration information used for monitoring the first neural network model includes configuration information of the first time window.

In some embodiments, the first information being used for the terminal device to monitor the first neural network model includes that:
in a case where a difference between an input parameter of the first neural network model and a verification parameter is greater than or equal to a first threshold, the first neural network model is invalid; and/or
in a case where the difference between the input parameter of the first neural network model and the verification parameter is less than the first threshold, the first neural network model is valid;
where a type of the input parameter of the first neural network model is the same as a type of the verification parameter.

In some embodiments, the first information being used for the terminal device to monitor the first neural network model includes that:
during monitoring of the first neural network model, in a case where the number of times that a difference between an input parameter of the first neural network model and a verification parameter is greater than or equal to a first threshold is greater than or equal to a second threshold, the terminal device determines that the first neural network model is invalid; and/or
during monitoring of the first neural network model, in a case where the number of times that the difference between the input parameter of the first neural network model and the verification parameter is greater than or equal to the first threshold is less than the second threshold, the terminal device determines that the first neural network model is valid;
where a type of the input parameter of the first neural network model is the same as a type of the verification parameter.

In some embodiments, the verification parameter is obtained by inverse deduction based on a prediction result of the first neural network model.

In some embodiments, the input parameter of the first neural network model includes at least one of the following: a downlink time difference of arrival (DL TDOA), a reference signal received power (RSRP), a downlink reference signal time difference (DL RSTD), a time of arrival (TOA), a downlink angle of departure (DL AoD), an uplink time difference of arrival (UL TDOA), an uplink relative time of arrival (UL RTOA), or an uplink angle of arrival (UL AoA).

In some embodiments, in a case where the terminal positioning method performed by the first neural network model is a DL TDOA positioning, the input parameter of the first neural network model includes at least one of the following: the DL TDOA, the RSRP, the DL RSTD, or the TOA.

In some embodiments, in a case where the terminal positioning method performed by the first neural network model is a DL AOD positioning, the input parameter of the first neural network model includes the DL AOD.

In some embodiments, in a case where the terminal positioning method performed by the first neural network model is a UL TDOA positioning, the input parameter of the first neural network model includes at least one of the following: the UL TDOA, the RSRP, or the UL RTOA.

In some embodiments, in a case where the terminal positioning method performed by the first neural network model is a UL AOA positioning, the input parameter of the first neural network model includes the UL AOA.

In some embodiments, the input parameter of the first neural network model is a parameter of the terminal device relative to a single transmission reception point (TRP), and the verification parameter is a verification parameter of the terminal device relative to the single TRP; or
the input parameter of the first neural network model is a parameter of the terminal device relative to multiple TRPs, and the verification parameter is a verification parameter of the terminal device relative to the multiple TRPs.

In some embodiments, in a case where the input parameter of the first neural network model is the parameter of the terminal device relative to the multiple TRPs, the difference between the input parameter of the first neural network model and the verification parameter being greater than or equal to the first threshold includes: a difference between a parameter of the terminal device relative to part or all of the multiple TRPs and a verification parameter of the terminal device relative to the corresponding TRP(s) is greater than or equal to the first threshold; and/or
in a case where the input parameter of the first neural network model is the parameter of the terminal device relative to the multiple TRPs, the difference between the input parameter of the first neural network model and the verification parameter being less than the first threshold includes: the difference between the parameter of the terminal device relative to part or all of the multiple TRPs and the verification parameter of the terminal device relative to the corresponding TRP(s) is less than the first threshold.

In some embodiments, the communication unit 410 is further configured to receive fourth information, where the fourth information is used for requesting an update of the network model, or the fourth information is used for indicating that the first neural network model has been invalid, or the fourth information is used for requesting that terminal positioning is to be implemented by another method.

In some embodiments, the fourth information includes information of at least one artificial intelligence (AI)/machine learning (ML) model supported by the terminal device and having the same function as that implementable by the first neural network model.

In some embodiments, the communication unit 410 is further configured to receive first capability information, where the first capability information includes type information of the AI/ML model supported by the terminal device.

In some embodiments, the communication unit 410 is further configured to transmit fifth information, where the fifth information includes at least one of the following: identification information of a second neural network model, configuration information of the second neural network model, or configuration information required for the second neural network model to perform online training. The second neural network model is a network model having the same function as that implementable by the first neural network model; and the fifth information is used for the terminal device to switch from the first neural network model to the second neural network model.

In some embodiments, the terminal device implements the function implementable by the first neural network model in another method within a first time duration;
where a start time of the first time duration is a time when the terminal device determines that the first neural network model is invalid, and an end time of the first time duration is a time when the terminal device successfully switches to the second neural network model.

In some embodiments, the communication unit mentioned above may be a communication interface or a transceiver, or an input/output interface of a communication chip or a system on chip.

It should be understood that the network device 400 in accordance with the embodiments of the present application may correspond to the network device in the method embodiments of the present application, and the above-mentioned and other operations and/or functions of each unit in the network device 400 are respectively for implementing a corresponding procedure of the network device in the method 200 shown in FIG. 7, which will not be repeated here for brevity.

FIG. 13 is a schematic structural diagram of a communication device 500 provided in the embodiments of the present application. The communication device 500 shown in FIG. 13 includes a processor 510. The processor 510 may call a computer program from a memory and run the computer program, to implement the method in the embodiments of the present application.

In some embodiments, as shown in FIG. 13, the communication device 500 may further include a memory 520. The processor 510 may call a computer program from the memory 520 and run the computer program to implement the method in the embodiments of the present application.

The memory 520 may be a separate device independent from the processor 510, or may be integrated into the processor 510.

In some embodiments, as shown in FIG. 13, the communication device 500 may further include a transceiver 530, and the processor 510 may control the transceiver 530 to communicate with other devices, and for example, to transmit information or data to other devices, or receive information or data transmitted by other devices.

Here, the transceiver 530 may include a transmitter and a receiver. The transceiver 530 may further include antenna(s), and the number of antenna(s) may be one or more.

In some embodiments, the processor 510 may implement a function of a processing unit in a terminal device, or the processor 510 may implement a function of a processing unit in a network device, which will not be repeated here for brevity.

In some embodiments, the transceiver 530 may implement a function of a communication unit in the terminal device, which will not be repeated here for brevity.

In some embodiments, the transceiver 530 may implement a function of a communication unit in the network device, which will not be repeated here for brevity.

In some embodiments, the communication device 500 may be a network device of the embodiments of the present application, and the communication device 500 may implement a corresponding procedure implementable by the network device in each method of the embodiments of the present application, which will not be repeated here for brevity.

In some embodiments, the communication device 500 may be a terminal device of the embodiments of the present application, and the communication device 500 may implement a corresponding procedure implementable by the terminal device in each method of the embodiments of the present application, which will not be repeated here for brevity.

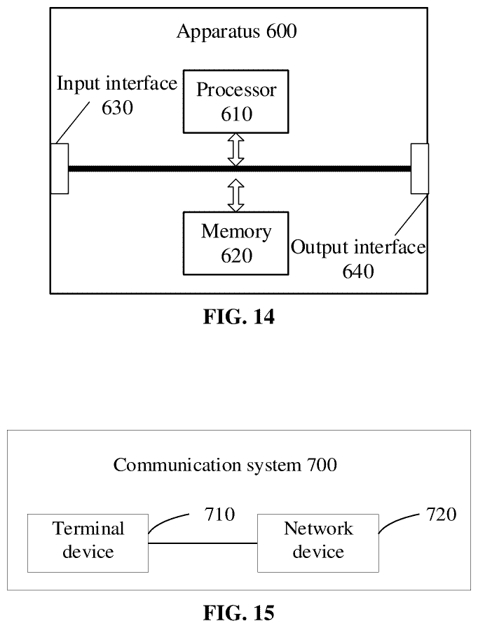

FIG. 14 is a schematic structural diagram of an apparatus of the embodiments of the present application. The apparatus 600 shown in FIG. 14 includes a processor 610, and the processor 610 may call a computer program from a memory and run the computer program to implement the method in the embodiments of the present application.

In some embodiments, as shown in FIG. 14, the apparatus 600 may further include a memory 620. The processor 610 may call a computer program from the memory 620 and run the computer program to implement the method in the embodiments of the present application.

The memory 620 may be a separate device independent from the processor 610, or may be integrated into the processor 610.

In some embodiments, the apparatus 600 may further include an input interface 630. The processor 610 may control the input interface 630 to communicate with other devices or chips, and for example, the input interface 630 may obtain information or data transmitted by other devices or chips. Optionally, the processor 610 may be located within a chip or outside the chip.

In some embodiments, the processor 610 may implement a function of a processing unit in a terminal device, or the processor 610 may implement a function of a processing unit in a network device, which will not be repeated here for brevity.

In some embodiments, the input interface 630 may implement a function of a communication unit in the terminal device, or the input interface 630 may implement a function of a communication unit in the network device.

In some embodiments, the apparatus 600 may further include an output interface 640. The processor 610 may control the output interface 640 to communicate with other devices or chips, and for example, the output interface 640 may output information or data to other devices or chips. Optionally, the processor 610 may be located within a chip or outside the chip.

In some embodiments, the output interface 640 may implement the function of the communication unit in the terminal device, or the output interface 640 may implement the function of the communication unit in the network device.

In some embodiments, the apparatus may be applied to the network device in the embodiments of the present application, and the apparatus may implement a corresponding procedure implementable by the network device in each method of the embodiments of the present application, which will not be repeated here for brevity.

In some embodiments, the apparatus may be applied to the terminal device in the embodiments of the present application, and the apparatus may implement a corresponding procedure implementable by the terminal device in each method of the embodiments of the present application, which will not be repeated here for brevity.

In some embodiments, the apparatus mentioned in the embodiments of the present application may be a chip. For example, it may be a system-level chip, a system on chip, a chip system, or a system-on-chip chip.

FIG. 15 is a schematic block diagram of a communication system 700 provided in the embodiments of the present application. As shown in FIG. 15, the communication system 700 includes a terminal device 710 and a network device 720.

Here, the terminal device 710 may be used to implement corresponding functions implementable by the terminal device in the above-mentioned methods, and the network device 720 may be used to implement corresponding functions implementable by the network device in the above-mentioned methods, which will not be repeated here for brevity.

It should be understood that the processor in the embodiments of the present application may be an integrated circuit chip and have a processing capability of signals. In the implementation process, various steps of the above method embodiments may be completed by an integrated logic circuit of hardware in the processor or instructions in a software form. The above processor may be a general-purpose processor, a digital signal processor (DSP), an application specific integrated circuit (ASIC), a field programmable gate array (FPGA) or other programmable logic devices, a discrete gate or transistor logic device, a discrete hardware component, or the like, which can implement or perform various methods, steps and logical block diagrams disclosed in the embodiments of the present application. A general-purpose processor may be a microprocessor, or the processor may be any conventional processor. The steps of the method disclosed in combination with the embodiments of the present application may be directly embodied as being performed and completed by a hardware decoding processor, or by using a combination of hardware and software modules in the decoding processor. The software module may be located in a non-transitory mature storage medium in the art such as a random memory, a flash memory, a read-only memory, a programmable read-only memory or electrically erasable programmable memory, a register, or the like. The non-transitory storage medium is located in the memory, and the processor reads the information in the memory and completes the steps of the above methods in combination with its hardware.

It may be understood that the memory in the embodiments of the present application may be a volatile (transitory) memory or a non-volatile (non-transitory) memory, or may include both volatile and non-volatile memories. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of illustration, but not limitation, many forms of RAMs are available, for example, a static random access memory (SRAM), a dynamic random access memory (Dynamic RAM, DRAM), a synchronous dynamic random access memory (SDRAM), a double data rate synchronous dynamic random access memory (DDR SDRAM), an enhanced synchronous dynamic random access memory (ESDRAM), a synchronous link dynamic random access memory (SLDRAM), and a direct rambus random access memory (DR RAM). It should be noted that the memory of the system and the method described herein is intended to include, but not limited to, these and any other suitable types of memories.

It should be understood that the above memory is exemplary but not limiting illustration, for example, the memory in the embodiments of the present application may be a static random access memory (static RAM, SRAM), a dynamic random access memory (DRAM), a synchronous DRAM (SDRAM), a double data rate SDRAM (DDR SDRAM), an enhanced SDRAM (ESDRAM), a synch link DRAM (SLDRAM), a direct rambus RAM (DR RAM), or the like. That is, the memory in the embodiments of the present application is intended to include, but not limited to, these and any other suitable types of memories.

The embodiments of the present application further provide a non-transitory computer-readable storage medium for storing a computer program.

In some embodiments, the non-transitory computer-readable storage medium may be applied to the network device in the embodiments of the present application, and the computer program enables a computer to perform a corresponding procedure implementable by the network device in each method of the embodiments of the present application, which will not be repeated here for brevity.

In some embodiments, the non-transitory computer-readable storage medium may be applied to the terminal device in the embodiments of the present application, and the computer program enables a computer to perform a corresponding procedure implementable by the terminal device in each method of the embodiments of the present application, which will not be repeated here for brevity.

The embodiments of the present application further provide a computer program product including a computer program instruction.

In some embodiments, the computer program product may be applied to the network device in the embodiments of the present application, and the computer program instruction enables a computer to perform a corresponding procedure implementable by the network device in each method of the embodiments of the present application, which will not be repeated here for brevity.

In some embodiments, the computer program product may be applied to the terminal device in the embodiments of the present application, and the computer program instruction enables a computer to perform a corresponding procedure implementable by the terminal device in each method of the embodiments of the present application, which will not be repeated here for brevity.

The embodiments of the present application further provide a computer program.

In some embodiments, the computer program may be applied to the network device in the embodiments of the present application, and the computer program, when being executed on a computer, enables the computer to perform a corresponding procedure implementable by the network device in each method of the embodiments of the present application, which will not be repeated here for brevity.

In some embodiments, the computer program may be applied to the terminal device in the embodiments of the present application, the computer program when being executed on a computer, enables the computer to perform a corresponding procedure implementable by the terminal device in each method of the embodiments of the present application, which will not be repeated here for brevity.

Those ordinary skilled in the art may realize that units and algorithm steps of various examples described in combination with the embodiments disclosed herein are capable of being implemented in electronic hardware or in a combination of computer software and electronic hardware. Whether these functions are performed by way of hardware or software depends on an application and a design constraint of the technical solution. A skilled person may use different methods for each application, to implement the described functions, but such implementation should not be considered beyond the scope of the present application.

It may be clearly understood by those skilled in the art that, for convenience and brevity of the description, working procedures of the system, apparatus and unit described above may refer to corresponding procedures in the above method embodiments, which will not be repeated here.

In the several embodiments provided by the present application, it should be understood that the system, apparatus, and method disclosed may be implemented in other methods. For example, the apparatus embodiments described above are only schematic, for example, the division of the units is only a division of logical functions, and there may be other division methods in an actual implementation, for example, multiple units or components may be combined or integrated into another system, or some features may be ignored or not performed. In addition, the coupling or direct coupling or communicative connection between each other as shown or discussed may be indirect coupling or communicative connection of apparatuses or units through some interfaces, which may be electrical, mechanical, or in other forms.

The units illustrated as separate components may be or may not be physically separated, and the components shown as units may be or may not be physical units, that is, they may be located in one place, or may be distributed onto multiple network units. A part or all of the units may be selected according to actual needs, to implement the purpose of the schemes of the embodiments.

In addition, the various functional units in the various embodiments of the present application may be integrated into one processing unit, or the various units may exist physically separately, or two or more units may be integrated into one unit.

If being implemented in the form of a software functional unit and sold or used as an independent product, the described functions may be stored in a non-transitory computer-readable storage medium. For such understanding, the technical solution of the present application essentially, or a part of the technical solution that contributes to the prior art, or a part of the technical solution, may be embodied in the form of a software product, and the computer software product is stored in a non-transitory storage medium, and includes several instructions for enabling a computer device (which may be a personal computer, a server, or a network device) to perform all or some of the steps of the methods described in the various embodiments of the present application. Moreover, the non-transitory storage mediums mentioned above include various mediums capable of storing program codes, such as a USB flash drive (U disk), a mobile hard disk, a read-only memory (ROM), a random access memory (RAM), a diskette, or an optical disk.

The above content is only implementations of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of the claims.

What is claimed is:

1. A model monitoring method, comprising:
receiving, by a terminal device, first information, wherein the first information comprises at least configuration information used for monitoring a first neural network model, and the first neural network model is used for performing terminal positioning; and
monitoring, by the terminal device, the first neural network model according to the first information.

2. The method according to claim 1, wherein the configuration information used for monitoring the first neural network model comprises configuration information of a reference signal used for monitoring the first neural network model.

3. The method according to claim 2, wherein the reference signal used for monitoring the first neural network model is a periodic reference signal or a reference signal with semi-persistent scheduling (SPS); wherein
the reference signal used for monitoring the first neural network model is one of following:
a downlink positioning reference signal (PRS), a sounding reference signal (SRS), a channel state information reference signal (CSI-RS), a synchronization signal block (SSB), or a demodulation reference signal (DMRS); wherein
the first information is carried in a long term evolution positioning protocol (LPP) message transmitted by a location management function (LMF) entity, or the first information is carried in a radio resource control (RRC) signaling;
or,
in a case where the reference signal used for monitoring the first neural network model is the downlink PRS, the first information is carried in an LPP message transmitted by an LMF entity; or
in a case where the reference signal used for monitoring the first neural network model is one of the SRS, the CSI-RS, the SSB, or the DMRS, the first information is carried in the RRC signaling.

4. The method according to claim 1, wherein monitoring, by the terminal device, the first neural network model according to the first information comprises:
monitoring, by the terminal device, the first neural network model within a first time window according to the first information.

5. The method according to claim 4, wherein the first time window is predefined, or the first time window is preconfigured, or the first time window is configured by the network device;
or,
the first time window is configured periodically, or the first time window is configured non-periodically;
or,
the configuration information used for monitoring the first neural network model comprises configuration information of the first time window.

6. The method according to claim 1, wherein monitoring, by the terminal device, the first neural network model according to the first information comprises:
in a case where a difference between an input parameter of the first neural network model and a verification parameter is greater than or equal to a first threshold, determining, by the terminal device, that the first neural network model is invalid; and/or
in a case where the difference between the input parameter of the first neural network model and the verification parameter is less than the first threshold, determining, by the terminal device, that the first neural network model is valid;
wherein a type of the input parameter of the first neural network model is the same as a type of the verification parameter;
or,
monitoring, by the terminal device, the first neural network model according to the first information comprises:
during monitoring of the first neural network model, in a case where a number of times that a difference between an input parameter of the first neural network model and a verification parameter is greater than or equal to a first threshold is greater than or equal to a second threshold, determining, by the terminal device, that the first neural network model is invalid; and/or
during monitoring of the first neural network model, in a case where the number of times that the difference between the input parameter of the first neural network model and the verification parameter is greater than or equal to the first threshold is less than the second threshold, determining, by the terminal device, that the first neural network model is valid;
wherein a type of the input parameter of the first neural network model is the same as a type of the verification parameter.

7. The method according to claim 6, wherein
the verification parameter is obtained by inverse deduction based on a prediction result of the first neural network model;
or,
the input parameter of the first neural network model comprises at least one of following: a downlink time difference of arrival (DL TDOA), a reference signal received power (RSRP), a downlink reference signal time difference (DL RSTD), a time of arrival (TOA), a downlink angle of departure (DL AoD), an uplink time difference of arrival (UL TDOA), an uplink relative time of arrival (UL RTOA), or an uplink angle of arrival (UL AoA).

8. The method according to claim 7, wherein
the input parameter of the first neural network model is a parameter of the terminal device relative to a single transmission reception point (TRP), and the verification parameter is a verification parameter of the terminal device relative to the single TRP; or
the input parameter of the first neural network model is a parameter of the terminal device relative to multiple TRPs, and the verification parameter is a verification parameter of the terminal device relative to the multiple TRPs; wherein
in a case where the input parameter of the first neural network model is the parameter of the terminal device relative to the multiple TRPs, the difference between the input parameter of the first neural network model and the verification parameter being greater than or equal to the first threshold comprises that: a difference between a parameter of the terminal device relative to part or all of the multiple TRPs and a verification parameter of the terminal device relative to the corresponding TRP(s) is greater than or equal to the first threshold; and/or
in a case where the input parameter of the first neural network model is the parameter of the terminal device relative to the multiple TRPs, the difference between the input parameter of the first neural network model and the verification parameter being less than the first threshold comprises that: the difference between the parameter of the terminal device relative to the part or all of the multiple TRPs and the verification parameter of the terminal device relative to the corresponding TRP(s) is less than the first threshold.

9. The method according to claim 6, wherein in a case where the terminal device determines that the first neural network model is invalid, the method further comprises:
transmitting, by the terminal device, fourth information, wherein the fourth information is used for requesting an update of the network model, or the fourth information is used for indicating that the first neural network model has been invalid, or the fourth information is used for requesting that the terminal positioning is to be implemented by another method; wherein
the method further comprises:
receiving, by the terminal device, fifth information, wherein the fifth information comprises at least one of following: identification information of a second neural network model, configuration information of the second neural network model, or configuration information required for the second neural network model to perform online training; and the second neural network model is an AI/ML model having a same function as that implementable by the first neural network model; and
switching, by the terminal device, from the first neural network model to the second neural network model.

10. A model monitoring method, comprising:
transmitting, by a network device, first information, wherein the first information comprises at least configuration information used for monitoring a first neural network model, and the first neural network model is used for performing terminal positioning; and the first information is used for a terminal device to monitor the first neural network model.

11. The method according to claim 10, wherein the configuration information used for monitoring the first neural network model comprises configuration information of a reference signal used for monitoring the first neural network model.

12. The method according to claim 11, wherein the reference signal used for monitoring the first neural network model is a periodic reference signal or a reference signal with semi-persistent scheduling (SPS); wherein
the reference signal used for monitoring the first neural network model is one of following:
a downlink positioning reference signal (PRS), a sounding reference signal (SRS), a channel state information reference signal (CSI-RS), a synchronization signal block (SSB), or a demodulation reference signal (DMRS); wherein
the first information is carried in a long term evolution positioning protocol (LPP) message transmitted by a location management function (LMF) entity, or the first information is carried in a radio resource control (RRC) signaling;
or,
in a case where the reference signal used for monitoring the first neural network model is the downlink PRS, the first information is carried in an LPP message transmitted by an LMF entity; or
in a case where the reference signal used for monitoring the first neural network model is one of the SRS, the CSI-RS, the SSB, or the DMRS, the first information is carried in the RRC signaling.

13. The method according to claim 10, wherein
the configuration information used for monitoring the first neural network model comprises at least one of following:
a monitoring period, a monitoring start time, a monitoring end time, a monitoring time window, a type of a monitoring reference signal, a period and/or time slot offset of the monitoring reference signal, a number of monitoring times, or a monitoring timer.

14. The method according to claim 10, wherein
before the network device transmits the first information, the method further comprises:
receiving, by the network device, second information, wherein the second information is used for requesting monitoring of the first neural network model, and the first information is determined based on the second information.

15. The method according to claim 14, wherein in a case where the configuration information used for monitoring the first neural network model is a downlink PRS used for monitoring the first neural network model, the second information is transmitted using an on-demand PRS mechanism; wherein
the second information comprises identification information of a downlink PRS configuration used for monitoring the first neural network model;
or,
the second information comprises downlink PRS parameter configuration information used for monitoring the first neural network model; wherein
the downlink PRS parameter configuration information used for monitoring the first neural network model comprises at least one of following:
a period of the PRS, a subcarrier spacing of the PRS, a cyclic prefix length of the PRS, a frequency domain resource bandwidth of the PRS, a frequency domain starting frequency location of a PRS resource, a frequency domain reference point A of the PRS, or a comb size of the PRS.

16. A terminal device, comprising a processor and a memory, wherein the memory is configured to store a computer program, and the processor is configured to call the computer program stored in the memory and run the computer program, to cause the terminal device to perform:
receiving first information, wherein the first information comprises at least configuration information used for monitoring a first neural network model, and the first neural network model is used for performing terminal positioning; and
monitoring the first neural network model according to the first information.

17. The terminal device according to claim 16, wherein
the configuration information used for monitoring the first neural network model comprises at least one of following:
a monitoring period, a monitoring start time, a monitoring end time, a monitoring time window, a type of a monitoring reference signal, a period and/or time slot offset of the monitoring reference signal, a number of monitoring times, or a monitoring timer.

18. The terminal device according to claim 16, wherein the terminal device further performs:
transmitting second information, wherein the second information is used for requesting monitoring of the first neural network model.

19. The terminal device according to claim 18, wherein in a case where the configuration information used for monitoring the first neural network model is a downlink PRS used for monitoring the first neural network model, the second information is transmitted using an on-demand PRS mechanism; wherein
the second information comprises identification information of a downlink PRS configuration used for monitoring the first neural network model;
or,
the second information comprises downlink PRS parameter configuration information used for monitoring the first neural network model; wherein
the downlink PRS parameter configuration information used for monitoring the first neural network model comprises at least one of following:
a period of the PRS, a subcarrier spacing of the PRS, a cyclic prefix length of the PRS, a frequency domain resource bandwidth of the PRS, a frequency domain starting frequency location of a PRS resource, a frequency domain reference point A of the PRS, or a comb size of the PRS.

20. The terminal device according to claim 18, wherein the second information comprises at least one of following:
a monitoring period, a monitoring start time, a monitoring end time, a monitoring time window, a type of a monitoring reference signal, a period and/or time slot offset of the monitoring reference signal, a number of monitoring times, or a monitoring timer.
